(19) United States
(12) Patent Application Publication
(10) Pub. No.: US 2016/0180017 A1
(43) Pub. Date: Jun. 23, 2016

(54) DESIGN OPTIMIZER SYSTEM AND METHODS

(71) Applicant: C&D ZODIAC, INC., Huntington Beach, CA (US)

(72) Inventors: Scott Savian, Huntington Beach, CA (US); Sandesh Shetty, Huntington Beach, CA (US); Roy Benjamin Sandberg, San Francisco, CA (US)

(21) Appl. No.: 15/059,162

(22) Filed: Mar. 2, 2016

Related U.S. Application Data
(63) Continuation-in-part of application No. 13/841,840, filed on Mar. 15, 2013.
(60) Provisional application No. 62/126,998, filed on Mar. 2, 2015.

(51) Int. Cl. G06F 17/50

(52) U.S. Cl. CPC G06F 17/5095

(57) ABSTRACT

A computerized system for determining the design layout of an aircraft. The system includes an input module configured to receive a first input data indicating a first value of a first parameter, a first feature database that includes a plurality of feature settings, a feature search module configured to search the first feature database and select a feature setting based on the first value of the first parameter, a central database that includes a plurality of rules governing a design layout of a fuselage, and an optimizing module in communication with the central database and configured to generate an optimal design layout based on the selected feature setting.

### CROSS REFERENCE TO RELATED APPLICATIONS

This application is a continuation-in-part of U.S. patent application Ser. No. 13/841,840, filed Mar. 15, 2013 and claims the benefit of U.S. Provisional Application No. 62/126,998, filed Mar. 2, 2015, both of which are incorporated by reference herein in their entireties.

### FIELD OF THE INVENTION

The present invention relates generally to semi-automatic design optimization. In particular, the invention provides a system and method to semi-automate the process of optimizing an aircraft interior solution (LOPA) to best support the customer/airline mission.

### BACKGROUND OF THE INVENTION

In certain applications, product design is highly individualized and depends on the particular needs of a specific customer. These are referred to as “custom” designs and are designed for a particular set of specifications making each manufactured product unique. In custom designs, since an array of product variations are offered to the customer, typically no two aircraft interiors are exactly the same. In custom designs, a design may be used for a single product or a relatively small quantity of manufactures. As such, the time and effort spent on each design directly adds to the cost and time necessary for the life cycle of a single product. In mass production, this design time and cost may be amortized among the thousands of manufactures and becomes a small part of the expense of each product. In custom design, by contrast, the design time and cost cannot be amortized in this way due to the relatively small number of products that may be manufactured from each design.

In commercial aviation, the interior space of an aircraft is an extremely valuable commodity. This is particularly true for aircraft that may be used for commercial passenger transfer, as the number of passengers on a given flight, together with the amount of revenue that may be generated from ticket sales for that flight (which itself is dependent on the market rate a passenger may be willing to pay for a given level of flight service), may determine whether operation of the flight will be profitable. Many other variables also exist that affect flight operation profitability, including the weight of the various seats and seat configurations that may be used, the number and type of aircraft galleys, lavatories, and other monuments (including the particular size and layout of such monuments), and the overall, general layout of the interior structures of an aircraft. Indeed, before an aircraft can be used for commercial passenger transport, its interior must be outfitted, configured, and optimized to account for these and other variables, so as to ensure that a carrier or aircraft owner's target goals for use of the aircraft can be achieved.

In the past, in order to outfit, configure, and optimize the interior of an aircraft to account for these many variables, a design engineer typically would have to manually attempt to plan the aircraft interior layout. This often would have to be done, in essence, through trial and error, where the design engineer manually creates an aircraft interior layout plan (a time intensive process of itself), and then assess the pros and cons of the particular layout and the manner in which the layout impacts the aforementioned variables, including the various weight parameters, the amount of revenue that could be generated per passenger for the particular layout, and whether the particular layout presents the greatest balance or optimization of the variables in order to achieve maximum profitability (or other target goals, as the case may be). Moreover, the ultimate layout of the aircraft interior often depends upon the specific skill level of the customer or individual designing the layout. As such, significant design variability and inefficiencies are inherent in such a process. In addition, an aircraft interior is comprised of thousands of parts, the configuration and implementation of which is necessarily a task that requires significant customization, and often results in the overall task taking months or years to complete. This is the case because aircraft interior layouts must be manually configured (an iterative process), and each iteration can take days to months or longer in some cases. The present invention eliminates or reduces these problems inherent in the prior art design methods.

On top of these challenges, design engineers also must account for specific and often rigorous governmental regulatory requirements concerning interior aircraft design, which challenge is further compounded because regulatory requirements often vary from one country to the next. And, once a specific layout plan has been manually created by the design engineer after a lengthy expenditure of time, to the extent the particular plan is not optimal, the engineer may have to spend considerable time modifying the plan (again, through a trial and error process or some use of existing designs) in order to optimize the interior layout plan to achieve the best balance of the many variables so as to achieve the targeted design goal. And as discussed above, even when a given layout for a particular aircraft, customer, and target goal has been achieved, it is very unlikely that any one particular “custom” layout will exactly match another customer's target goals, where the customer has another aircraft needing an interior layout design. This often may be true, even where the aircraft type or model is identical. As such, the time intensive interior layout and design process must be repeated from the beginning.

In light of these and other challenges in the prior art, there exists a need for a system and method to automate or semi-automate the process of interior aircraft design, such that a design engineer can readily and quickly configure and optimize the interior layout plan for an aircraft, and then easily adjust various aspects and ascertain, in real time, the ramifications of such adjustments vis-à-vis the various variables discussed above.

### SUMMARY OF THE PREFERRED EMBODIMENTS

In accordance with a first aspect of the present invention, there is provided a computerized system for determining the design layout of an aircraft. The system includes an input module configured to receive a first input data indicating a first value of a first parameter, a first feature database that includes a plurality of feature settings, a feature search module configured to search the first feature database and select a feature setting based on the first value of the first parameter, a central database that includes a plurality of rules governing a design layout of a fuselage, and an optimizing module in communication with the central database and configured to generate an optimal design layout based on the selected feature setting. In a preferred embodiment, the input module is further configured to receive a second input data indicating a first value of a second parameter. The feature search module is further configured to search the first feature database and select the feature setting based on the first value of the first parameter and the first value of the second parameter. In a preferred embodiment, the first parameter is comfort level or flight duration. In another embodiment, the first parameter is comfort level and the second parameter is flight duration.

In a preferred embodiment, the optimizing module is further configured to apply at least one of the plurality of rules to generate a list of possible combinations of aircraft component layout configurations. The optimizing module is configured to generate an optimal layout configuration by selecting, based on the selected feature setting, one aircraft component layout configuration from the list of possible combinations of aircraft component layout configurations. Preferably, the optimizing module is further configured to generate an optimal design layout by determining and selecting the one configuration, from the list of possible combinations of aircraft component layout configurations, that provides for the greatest number of seats. The optimal design layout can also be the configuration that provides for the least amount of seat compromise, the most amount of free space and/or a highest monument ranking.

In accordance with another aspect of the present invention there is provided a computer-implemented method for optimizing the design layout of an aircraft. The method includes receiving a first input data indicating a first value of a first parameter, searching a first feature database and selecting a feature setting based on the first value of the first parameter, and generating an optimal design layout based on the selected feature setting. In a preferred embodiment, the method also includes receiving a second input data indicating a first value of a second parameter, and searching the first feature database and selecting the feature setting based on the first value of the first parameter and the first value of the second parameter. Preferably, the step of generating an optimal design layout further includes generating a list of possible combinations of aircraft component layout configurations, and selecting, based on the selected feature setting, one aircraft component layout configuration from the list of possible combinations of aircraft component layout configurations.

In accordance with an aspect of the present invention, there is provided a computerized system for optimizing the design layout of an aircraft configured to execute, by at least one processor, the instructions of one or more software modules stored on a nonvolatile computer readable medium, the system comprising a first software module configured to receive input from a user regarding number of seats; a second software module configured to receive input from a user regarding seat pitch; a third software module configured to receive input from a user regarding meal service; a fourth software module configured to receive input from a user regarding beverage service; a fifth software module configured to comprise a listing of all possible combinations of all aircraft interior layout configurations for an aircraft. The sixth software module uses the inputs from one or more of the first, second, third, or fourth software modules to determine and create an output of the one configuration that takes up the least amount of seat space, weighs the least, and contains the most amount of aircraft cabin storage space. A seventh software module graphically displays the output of the sixth software module.

In a preferred embodiment of the present invention, the system further comprises an eighth software module configured to receive input from a user regarding level of service, and the sixth software module may use input from the eighth software module to determine and create an output of the one configuration that takes up the least amount of seat space, weighs the least, and contains the most amount of aircraft cabin storage space. Preferably, the system further comprises a ninth software module configured to receive input from a user regarding flight duration, and wherein the sixth software module may use input from the ninth software module to determine and create an output of the one configuration that takes up the least amount of seat space, weighs the least, and contains the most amount of aircraft cabin storage space. Preferably, the fifth software module comprises separate lists for two or more different aircraft. Preferably, the system further comprises a tenth software module configured to receive input from a user regarding aircraft type, which input from the tenth software module regarding aircraft type causes the sixth software module to identify the one configuration that takes up the least amount of seat space, weighs the least, and contains the most amount of aircraft cabin storage space, from among the configurations that are listed in the separate list in the fifth software module corresponding to the aircraft type input from the tenth software module. Preferably, the graphical display of the seventh software module includes the position of one or more seats. Preferably, the graphical display of the seventh software module includes the position and type of one or more aircraft interior monuments. Preferably, the system further comprises an eleventh software module, which eleventh software module is configured to provide the weight of one or more aircraft interior layouts. Preferably, the system further comprises a twelfth software module, which twelfth software module is configured to provide the revenue generated from ticket sales for the aircraft interior layout configuration combination identified by the sixth software module. Preferably, the output of the sixth software module is printed on paper by a printer.

In accordance with another aspect of the present invention there is provided a method for optimizing the design layout of an aircraft by a user accessing software instructions stored on a nonvolatile computer readable medium, which software instructions are executed by at least one processor. The method comprises: receiving input from the user regarding number of seats; receiving input from the user regarding seat pitch; receiving input from the user regarding meal service; receiving input from the user regarding beverage service; listing all possible combinations of all aircraft interior layout configurations for an aircraft; determining and creating an output of the one configuration that takes up the least amount of seat space, weighs the least, and contains the most amount of aircraft cabin storage space; and graphically displaying the output of the one configuration that takes up the least amount of seat space, weighs the least, and contains the most amount of aircraft cabin storage space.

In a preferred embodiment, the method further comprises receiving input regarding level of service, and wherein the input regarding level of service may be used to determine and create an output of the one configuration that takes up the least amount of seat space, weighs the least, and contains the most amount of aircraft cabin storage space. Preferably, the method further comprises receiving input regarding flight duration, and wherein the input regarding flight duration may be used to determine and create an output of the one configuration that takes up the least amount of seat space, weighs the least, and contains the most amount of aircraft cabin storage space. Preferably, separate aircraft layout configuration lists for two or more different aircraft are created. Preferably, the method further comprises receiving input regarding aircraft type, which input regarding aircraft type is used to identify the one configuration that takes up the least amount of seat space, weighs the least, and contains the most amount of aircraft cabin storage space, from among the separate list of aircraft layout configurations corresponding to the input regarding aircraft type. Preferably, the graphical display includes the position of one or more seats. Preferably, the graphical display includes the position and type of one or more aircraft interior monuments. Preferably, the weight of one or more aircraft interior layouts is determined and presented. Preferably, the revenue generated from ticket sales for the aircraft interior layout configuration that takes up the least amount of seat space, weighs the least, and contains the most amount of aircraft cabin storage space, is determined and presented. Preferably, the output of the one configuration that takes up the least amount of seat space, weighs the least, and contains the most amount of aircraft cabin storage space, is printed on paper by a printer.

The invention, together with additional features and advantages thereof, may be best understood by reference to the following description.

### BRIEF DESCRIPTION OF THE DRAWINGS

FIG. 1 is a block diagram of a computerized design optimizer in accordance with an embodiment of the present invention;

FIG. 2 is a block diagram of an overview flow chart of a computerized design optimizer in accordance with an embodiment of the present invention;

FIG. 3 is a block diagram of an overview flow chart of a computerized design optimizer in accordance with an embodiment of the present invention;

FIG. 4 is a block diagram of a detailed flow chart of a computerized design optimizer in accordance with an embodiment of the present invention;

FIG. 5 is an exemplar screen shot showing the features, input controls, and output controls/results of a computerized optimizer in accordance with an embodiment of the present invention;

FIG. 6 is an exemplar screen shot showing the features, input controls, and output controls/results of a computerized optimizer in accordance with an embodiment of the present invention;

FIG. 7 is an exemplar screen shot showing the features, input controls, and output controls/results of a computerized optimizer in accordance with an embodiment of the present invention;

FIG. 8 is an exemplar screen shot showing information output of a computerized optimizer in accordance with an embodiment of the present invention;

FIG. 9 is an exemplar screen shot showing the features, input controls, and output controls/results of a computerized optimizer in accordance with an embodiment of the present invention;

FIG. 10 is an exemplar screen shot showing information output of a computerized optimizer in accordance with an embodiment of the present invention;

FIG. 11 is an exemplar screen shot showing the features, input controls, and output controls/results of a computerized optimizer in accordance with an embodiment of the present invention;

FIG. 12 is an exemplar screen shot showing information output of a computerized optimizer in accordance with an embodiment of the present invention;

FIG. 13 is an exemplar screen shot showing the features, input controls, and output controls/results of a computerized optimizer in accordance with an embodiment of the present invention;

FIG. 14 is an exemplar screen shot showing information output of a computerized optimizer in accordance with an embodiment of the present invention;

FIG. 15 is a diagram conceptually illustrating the architecture of a computerized optimizer in accordance with a preferred embodiment of the present invention;

FIG. 16 is a diagram depicting the tables of a central database in accordance with a preferred embodiment of the present invention;

FIG. 17 is a flow chart illustrating the basic operation of a computerized optimizer in accordance with a preferred embodiment of the present invention;

FIG. 18 is a flow chart demonstrating the operation of a subsection of a software application that loads customer specific configuration data and initial defaults in accordance with a preferred embodiment of the present invention;

FIG. 19 is a flow chart detailing the interactions between a software application and a central database in accordance with a preferred embodiment of the present invention;

FIG. 20 is a flow chart detailing the interactions between a software application and a central database when a new flight duration and/or comfort level setting is selected by a user in accordance with a preferred embodiment of the present invention;

FIG. 21 is a flow chart illustrating the algorithm performed by a software application to generate and display an optimized LOPA in accordance with a preferred embodiment of the present invention;

FIG. 22 is a flow chart illustrating a subsection of a software application that fills leftover space by enlarging monuments, in accordance with a preferred embodiment of the present invention;

FIG. 23 is a flow chart illustrating the algorithm performed by an optimizing module to place seats within an airframe for each seat class and calculate the total number of seats in each seat class, in accordance with a preferred embodiment of the present invention;

FIG. 24 is an exemplary graphic user interface of a software application in accordance with a preferred embodiment of the present invention;

FIG. 25 is an exemplar screen shot showing the user interface of a software application in accordance with a preferred embodiment of the present invention;

FIG. 26 is an exemplar screen shot showing the user interface of a software application in accordance with a preferred embodiment of the present invention;

FIG. 27 is an exemplar screen shot showing the detailed fuselage comparison feature of a software application in accordance with a preferred embodiment of the present invention;

FIG. 28 is an exemplar screen shot showing the basic fuselage comparison feature of a software application in accordance with a preferred embodiment of the present invention;

FIG. 29 is an exemplar screen shot of a software application 400 showing a wardrobe configuration panel in accordance with a preferred embodiment of the present invention;

FIG. 30 is an exemplar screen shot showing a seat configuration panel provided by a software application in accordance with a preferred embodiment of the present invention;

FIG. 31 is an exemplar screen shot showing a divider configuration panel provided by a software application in accordance with a preferred embodiment of the present invention;

FIG. 32 is an exemplar screen shot showing a catering configuration panel provided by a software application in accordance with a preferred embodiment of the present invention;

FIG. 33 is an exemplar screen shot showing an application overflow menu provided by a software application in accordance with a preferred embodiment of the present invention;

FIG. 34 is an exemplar screen shot showing a resources configuration panel provided by a software application in accordance with a preferred embodiment of the present invention;

FIG. 35 is an exemplar screen shot showing a lavatory configuration panel provided by a software application in accordance with a preferred embodiment of the present invention;

FIG. 36 is an exemplar screen shot showing a duration and level of comfort administration selection dialog provided by a software application in accordance with a preferred embodiment of the present invention;

FIG. 37 is an exemplar screen shot showing a duration and level of comfort administration selection dialog provided by a software application in accordance with a preferred embodiment of the present invention;

FIG. 38 is an exemplar screen shot showing an emergency equipment configuration dialog provided by a software application in accordance with a preferred embodiment of the present invention;

FIG. 39 is an exemplar screen shot showing a global settings dialog provided by a software application in accordance with a preferred embodiment of the present invention; and

FIG. 40 is an exemplar screen shot showing a report generation dialog provided by a software application in accordance with a preferred embodiment of the present invention.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

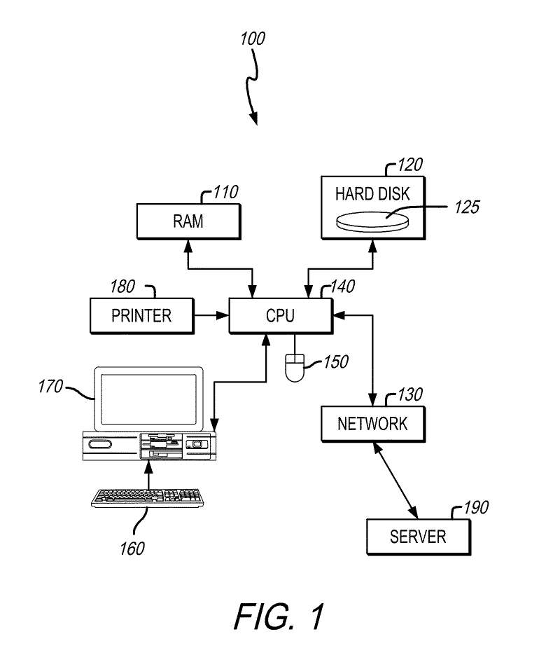

Referring now to the drawings, which are for purposes of illustrating the present invention and not for purposes of limiting the same, FIG. 1, is a block diagram showing a computerized design optimizer system 100 in accordance with the present invention. Preferably, system 100 comprises a computer device capable of receiving user initiated input commands, processing data, and outputting the results for the user. System 100 consists of RAM (memory) 110, hard disk 120, network 130, central processing unit (CPU) 140, mouse 150, keyboard 160, video display 170, a printer 180, and a server 190. It will be understood and appreciated by those of skill in the art that the computer device of system 100 could be replaced with, or augmented by, any number of other computer device types or processing units, including but not limited to a desktop computer, laptop computer, mobile or tablet device, or the like. Similarly, hard disk 120 could be replaced with any number of computer storage devices, including flash drives, removable media storage devices (CDs, DVDs, etc.), or the like.

Network 130 can consist of any network type, including but not limited to a local area network (LAN), wide area network (WAN), and/or the internet. Server 190 can consist of any computing device or combination thereof, including but not limited to the computing devices described herein, such as a desktop computer, laptop computer, mobile or tablet device, as well as storage devices that may be connected to network 130, such as hard drives, flash drives, removable media storage devices, or the like.

The storage devices (e.g., hard disk 120, server 190, or other devices known to persons of ordinary skill in the art), are intended to be nonvolatile, computer readable storage media to provide storage of computer-executable instructions, data structures, program modules, and other data for the computing device of system 100, which are executed by CPU/processor 140 (or the corresponding processor of such other components). The various components of the present invention, modules or steps 125, are stored or recorded on hard disk 120 or other like storage devices described above, which may be accessed and utilized by the computing device of system 100, the server 190 (over network 130), or any of the peripheral devices described herein, including video display 170 and/or printer 180. One or more of the modules or steps 125 of the present invention also may be stored or recorded on server 190, and transmitted over network 130, to be accessed and utilized by the computer device of system 100, or any other computing device that may be connected to one or more of the computing devices of system 100, the network 130, and/or the server 190.

Software and web or internet implementations of the present invention could be accomplished with standard programming techniques with rule based logic and other logic to accomplish the various steps of the present invention described herein. It should also be noted that the terms “component,” “module,” or “step,” as may be used herein and in the claims, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

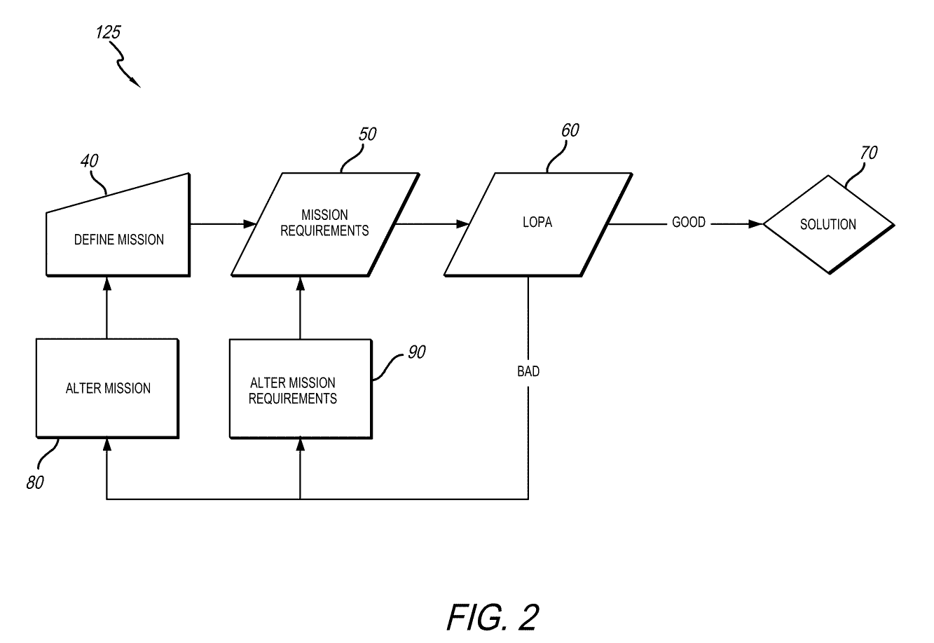

Referring now to FIG. 2, a block diagram of a high level overview flow chart of a computerized design optimizer in accordance with the present invention is shown. In particular, FIG. 2 is intended to represent a high level strategy for the system of the present invention. The first step is to define the mission, i.e., the goals or aspirations of the customer/airline and what it wants to achieve in a particular aircraft interior configuration layout (step 40). Next, mission requirements to attain the customer/airline goals are compiled and assimilated (step 50). Next, a layout of passenger accommodations (referred to herein as a LOPA, design configuration, or design layout) is generated based upon the customer/airline goals (step 60). Depending upon whether the resulting LOPA meets or does not meet the customer airline goals (i.e., good or bad), the mission and/or mission requirements may be modified (steps 80 and 90), and ultimately, a desirable outcome or solution is achieved (step 70).

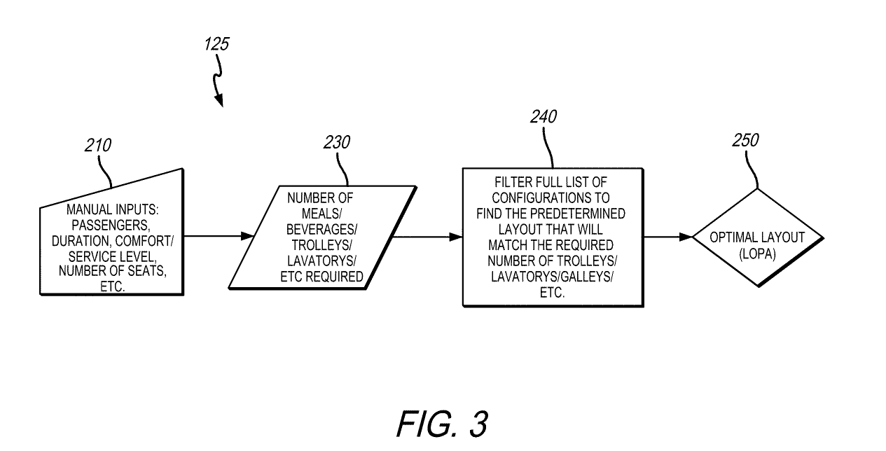

Referring now to FIG. 3, a block diagram of an overview flow chart of a computerized design optimizer in accordance with the present invention is shown. At first module or step 210 of the present invention, manual user inputs are provided. These include the level of comfort or level of service (which may be defined on a sliding scale from, for example, 1 through 10), the duration of the flight (which may be defined on a sliding scale from, for example, 1 through 6), the number of passengers on a given flight, the number of seats required, etc. Level of comfort or level of service refers to the overall level of passenger experience and comprises aspects such as quality of seats (e.g., leather vs. cloth), quality of meals (gourmet entrée items vs. cold meals vs. light snack service), general or specific seat pitch, etc. Once the inputs of module or step 210 have been made, module or step 230 determines the number of meals, beverages, trolleys, lavatories, galleys, ovens, and coffee makers required, and the space requirements for one or more of these items. Module or step 240, which contains a list of all possible layout configurations for a given aircraft, is then filtered down to determine the configuration that best fits the input values, and the number and space requirements of the various identified monuments and accessories. Module or step 250 provides an output of the optimal layout.

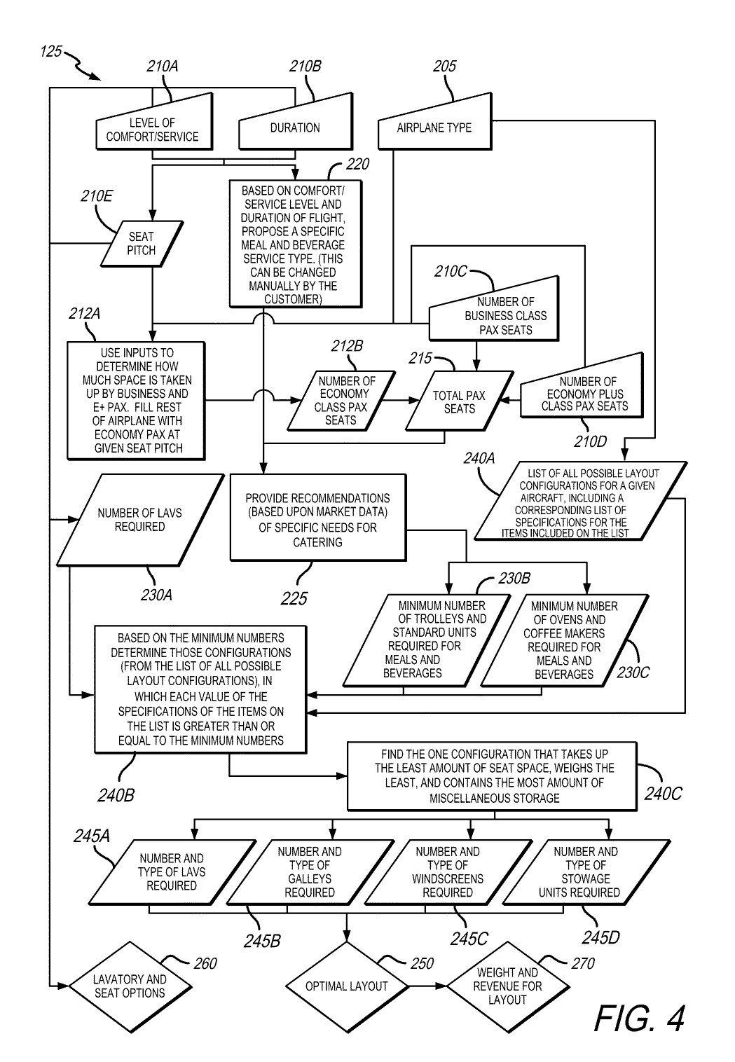

Referring now to FIG. 4, a block diagram of a detailed flow chart of a computerized design optimizer in accordance with the present invention is shown. At module or step 205, the specific aircraft type is selected from among a list of possible aircraft types. The selection of specific aircraft type at module or step 205 dictates the list of all possible layout configurations (240A), as the universe of combinations is aircraft specific (in light of variances among interior dimensions and other variables as between different aircraft types). Layout list 240A is comprised of a master list of all possible layout configurations for a given aircraft. Further, layout list 240A groups and configures the list of all possible lavatories, galleys, trolleys, and other monuments and accessories, such that all possible combinations and layouts of all such items are listed, as will be understood and appreciated by those of skill in the art. Layout list 240A also includes a corresponding list of the specifications of the items and other monuments and accessories (i.e., specific physical attributes and features, including but not limited to weight, dimensions, volume, and other such physical attributes and features as would be recognized by those of skill in the art).

At module or step 210A, the level of comfort/service (which may be on a sliding scale, for example, of 1 through 10) is selected. A higher number may denote a higher level of comfort/service, and a lower number may denote a lower level of comfort/service. As discussed, level of comfort or level of service refers to the overall level of passenger experience and comprises aspects such as quality of seats (e.g., leather vs. cloth), quality of meals (gourmet entrée items vs. cold meals vs. light snack service), general or specific seat pitch, etc. At module or step 210B, the duration of the flight (which may be on a sliding scale, for example, of 1 through 6) is selected. A higher number may denote a longer flight duration, and a lower number may denote a shorter flight duration.

From the inputs at modules or steps 210A and 210B, module or step 220 determines the level of service that will be required and makes a determination of the specific meal and beverage service type for a given flight, as well as a recommended seat pitch 210C. The level of service and the seat pitch also may be manually adjusted by user inputs. Module or step 225 provides recommendations (based upon market data) of specific needs for catering. Such market research may be performed in advance, and the results of the market research stored at module or step 225. In such a preferred embodiment, module or step 225 applies the inputs to the stored market research data.

At module or steps 210C and 210D, the number of business class passengers and economy plus class passengers are selected. At module or step 212A, all inputs, including comfort level 210A, duration 210B, number of business class passengers 210C, number of economy plus class passengers 210D, and seat pitch 210E are used to determine how much space is occupied by the business and economy plus class passenger seats, and the number of economy seats that can fit into the remainder of the aircraft is determined and presented at module or step 212B. Module 215 determines and presents the total number of passengers for the aircraft.

Based on the prior input, module or step 230A determines and presents the number of lavatories needed; module or step 230B determines the minimum number of trolleys and standard units required for meals and beverages. Module or step 230C determines the minimum number of ovens and coffee makers required for meals and beverages.

Based on the minimum values determined at module or steps 230B and 230C, module 240B determines those configurations (from the list of all possible layout configurations of module or step 240A), in which each value of the physical attribute specifications of the items on the list is greater than or equal to the minimum numbers determined at module or steps 230B and 230C. Module or step 240C then finds the one configuration (from those identified by module or step 240B) that takes up the least amount of seat space, weighs the least, and contains the most amount of miscellaneous storage space. In other words, modules or steps 240B and 240C, in effect, filter down the full list of all possible layout configurations (found at module or step 240A) and determine which single layout configuration best fits with the input values. The number and type of lavatories required is determined and presented at module or step 245A. The number and type of galleys required is determined and presented at module or step 245B. The number and type of windscreens required is determined at module or step 245C. The number and type of stowage units required is determined and presented at module or step 245D. The lavatory and seating options are determined and presented at module or step 260. Because the weight of the seating and the various components comprising the single configuration are known, the individual and total weight may be determined and presented at module or step 270. In addition, because the specific number of passengers, as well as the number of specific passengers for each fare class is known, an estimated flight revenue is determined and presented at module or step 270. It is contemplated and intended to be within the scope of the present invention that any determination and presentation described herein may be determined by way of CPU 140 or server 190, using data stored on hard disk 120, and may be transmitted across network 130. Moreover, it is contemplated and intended to be within the scope of the present invention that any determination and presentation, including any outputs described herein, may be presented to a user on display 170 and/or in hard copy or paper format by way of printer 180.

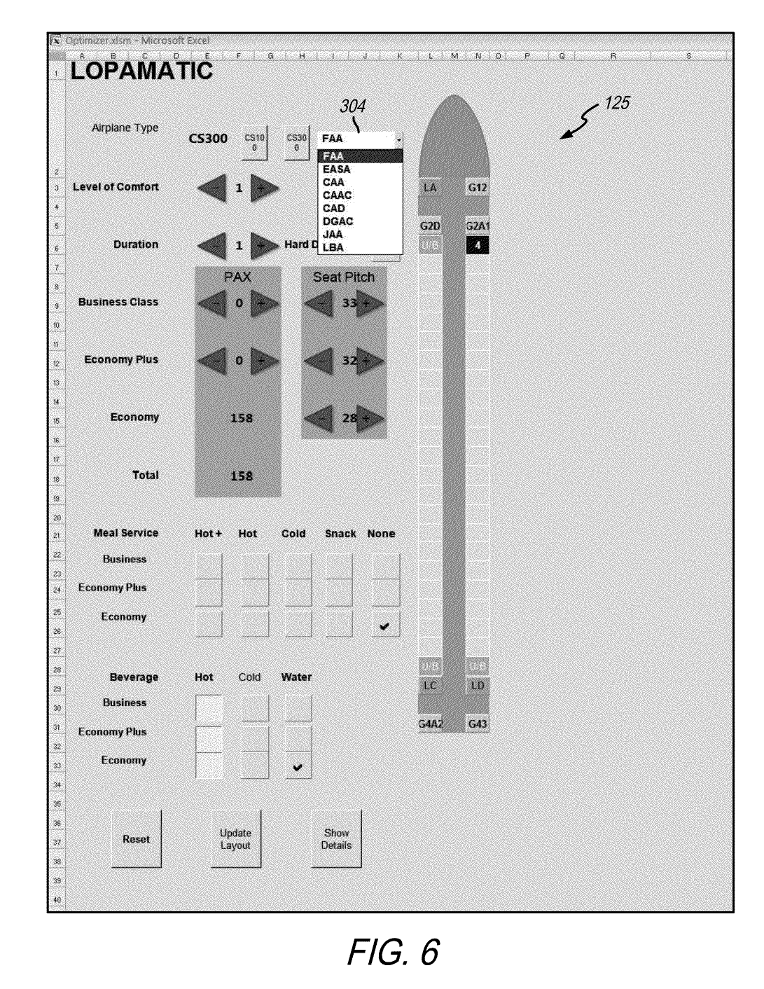

While the present diagrams of FIGS. 3 and 4 contemplate implementation of aircraft interior layout specifications using regulatory requirements of the Federal Aviation Administration in the United States, it is contemplated and intended that the present invention include and cover the selection and use of interior layout specifications using the regulatory requirements of other entities, including regulatory bodies of other countries (as depicted and shown, for example, by drop-down menu 304 of FIG. 6). It is also contemplated and intended to be within the scope of the present invention to include country specific or regional specific options, the selection of which tailors aircraft layout options and resulting configurations to match (or be consistent with), parameters or requirements of such country or region.

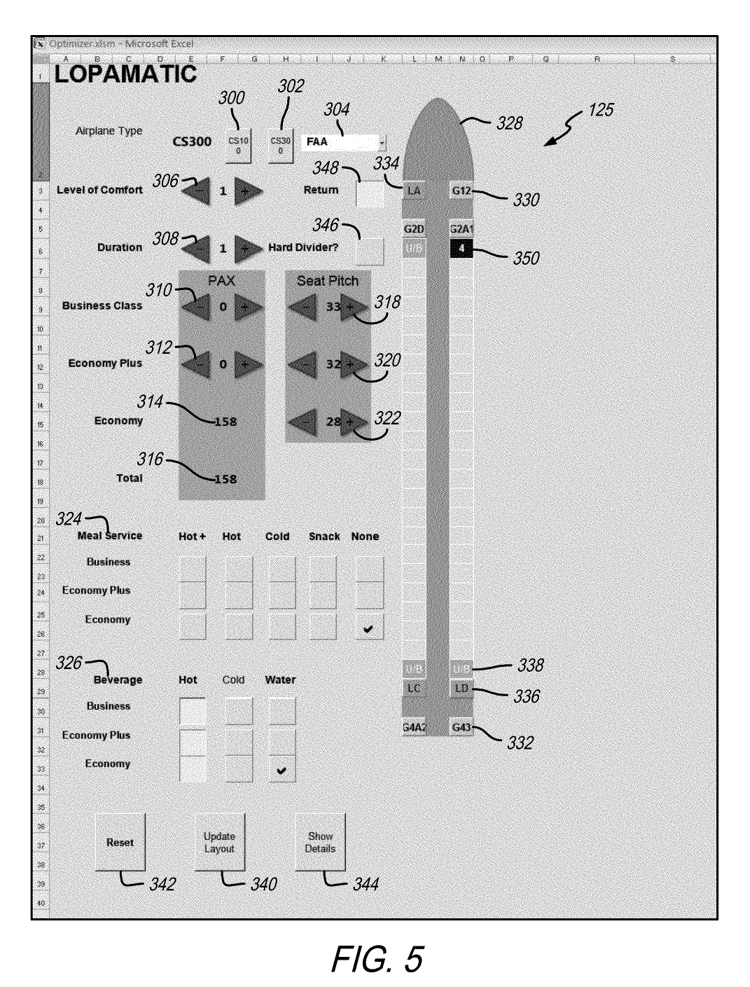

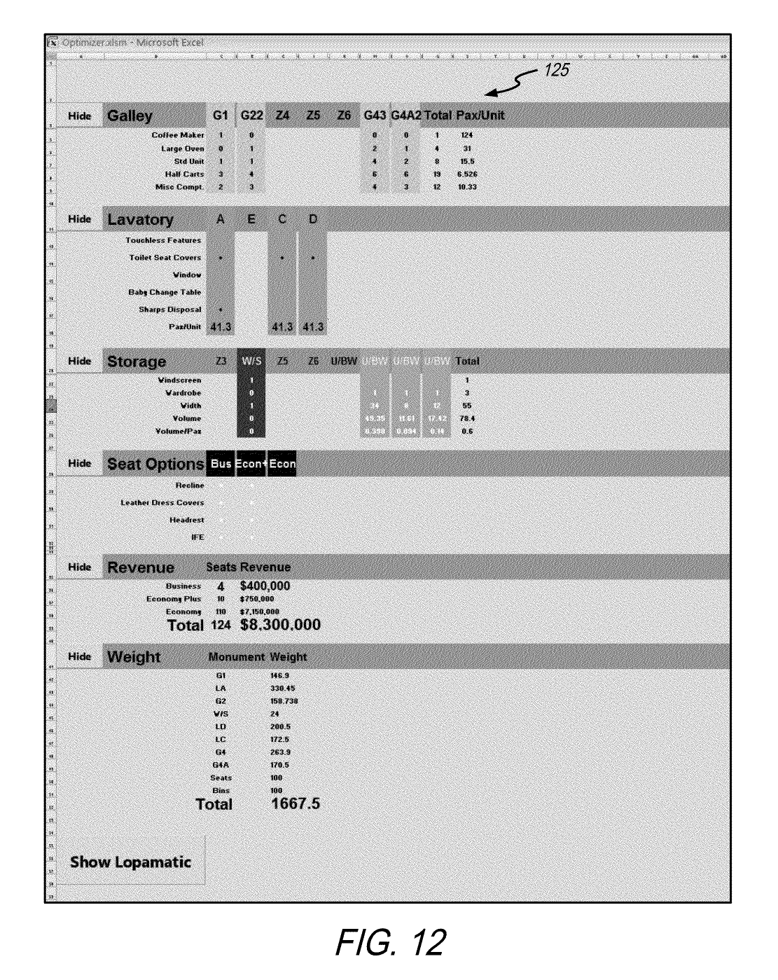

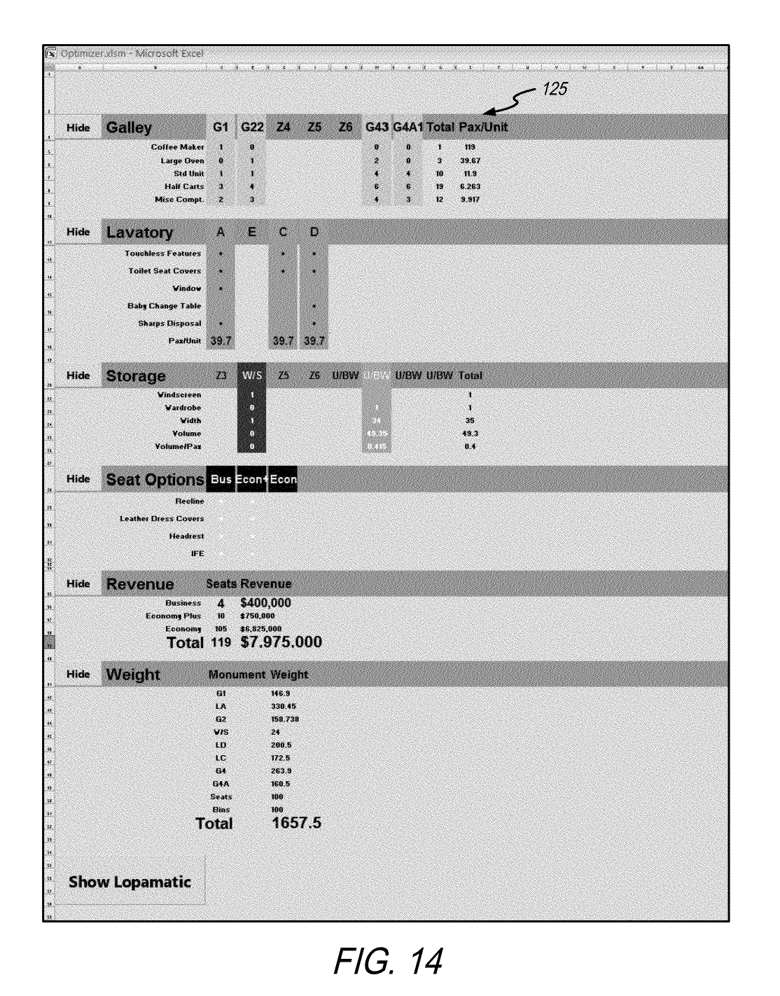

Referring to FIGS. 5 through 14, exemplar screen shots of an embodiment in accordance with the present invention are shown. The user interface in the embodiment shown in FIGS. 5 through 14 comprises graphical “buttons,” check-boxes, drop-down menus, and the like, which may be manipulated on screen by the user, such as by way of mouse 150 and display 170. Other means for achieving alternate forms of a user interface are known in the art and intended to be within the scope of the present disclosure.

Referring now to FIG. 5, the interface includes buttons 300 and 302, which allow a user to select a different aircraft type. Here, Bombardier CS100 and CS300 aircraft types are shown as options (and the CS300 aircraft type is shown as being selected). However, any other model or aircraft type may be included and is contemplated to be within the scope of the present invention. Drop-down menu 304 includes regulatory settings of various regulatory agencies, which can be selected (as shown in FIG. 6) and can be modified. The level of comfort/service (210A) may be input and modified by buttons 306. The flight duration (210B) may be input and modified by buttons 308. The number of business class passengers (210C) may be input and modified by buttons 310. The number of economy plus class passengers (210D) may be input and modified by buttons 312. The number of economy seats (212B) is presented at location 314, and the total passengers (215) are presented at location 316. Seat pitch (210E) for each respective class type is presented at buttons 318, 319, and 320. Seat pitch (210E) also may be input and modified by buttons 318, 319, and 320, for each respective class type.

Meal service (a portion of module or step 220) is shown at 324. Meal service (220), as shown at 324, is both an output of module 220, as well as an input, thus allowing a user to customize the selection. Beverage type (a portion of module or step 220) is shown at 326. Beverage type (220), as shown at 326, also is both an output of module 220, as well as an input, thus allowing a user to customize this selection as well.

Specific seat configurations are presented by way of a LOPA 328. Depending on the specific determinations made (as described herein), various monument types and placements are automatically provided and shown. For example, a type “1” galley is shown at 330 in the forward portion of the aircraft, and a type “4” galley is shown at 332 in the aft portion of the aircraft. The number “2” in the type 1 galley shown at 330 is intended to refer to a particular type 1 galley, and likewise, the number “3” in the type 4 galley shown at 332 is intended to refer to a particular type 4 galley. A type “A” lavatory is shown at 334 in the forward portion of the aircraft, and a type “D” lavatory is shown at 336 in the aft portion of the aircraft. Storage bins are shown at 338 in the aft portion of the aircraft.

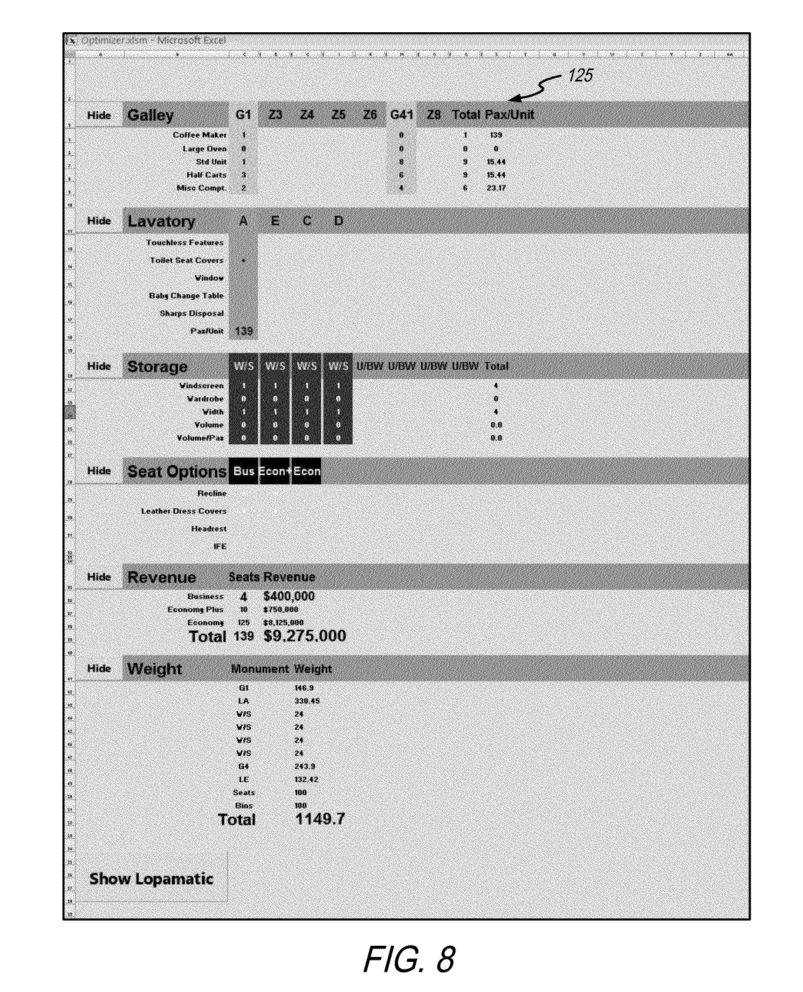

“Update Layout” button 340 updates the LOPA 328, and other output variables, to the extent manual modifications are made to the inputs. The disclosure of the present invention also includes “real time” updating of LOPA 328 from user inputs, without having to press the update layout button 340. “Reset” button 342 is used to return the LOPA 328 and all input controls to their original state. “Show Details” button 344 presents the user with other output information (such as module or step 270). Such output information is depicted in FIGS. 8, 10, 12, and 14, for example. The “Return” check-box 348 allows the user to set up a configuration scenario where a given aircraft might need to be configured for an out-and-back trip, where restocking of the galley and other supplies might not be possible. In that scenario, when the “Return” check-box 348 is selected, adjustments are made to the aircraft configuration, such as by including larger galleys or increasing the number of galleys, for more storage space for example, in order to accommodate the fact that restocking after the first leg of the trip may not be possible. “Hard Divider” button 346 allows a user to specify whether the class divider in the aircraft is a hard or soft divider, and depending on the selection, modifications are made to the layout to accommodate the difference in size and weight as between these types of dividers.

It is contemplated that the graphical interface of the present invention also may include one or more check boxes or other graphical selection mechanisms, whereby different oxygen delivery methods can be selected. Depending on the specific type of oxygen delivery method that is used (e.g., chemical method as opposed to gaseous method), a cylinder may need to be placed above each seat row, and the diameter of the cylinder determines the space required for the PSU. This in turn will affect the number of seat rows, given that every seat will need a PSU. By selecting a particular oxygen delivery method, it is contemplated that software system of the present invention will automatically account for the selected oxygen delivery method, determine the proper placement of the PSU, and adjust or readjust the aircraft layout, including the seating configuration and layout, accordingly. Likewise, it is also contemplated that the graphical interface of the present invention also may include a drop down menu or other graphical selection mechanisms, whereby different seat types and/or seat features may be selected. Types of seats and seat features affects the seat pitch, which in turn affects the number of seats that may be used in a given configuration. By selecting a particular seat type or feature, it is contemplated that the software system of the present invention will automatically account for the specific seat type selected, and adjust or readjust the aircraft layout, including the seating configuration and layout, accordingly.

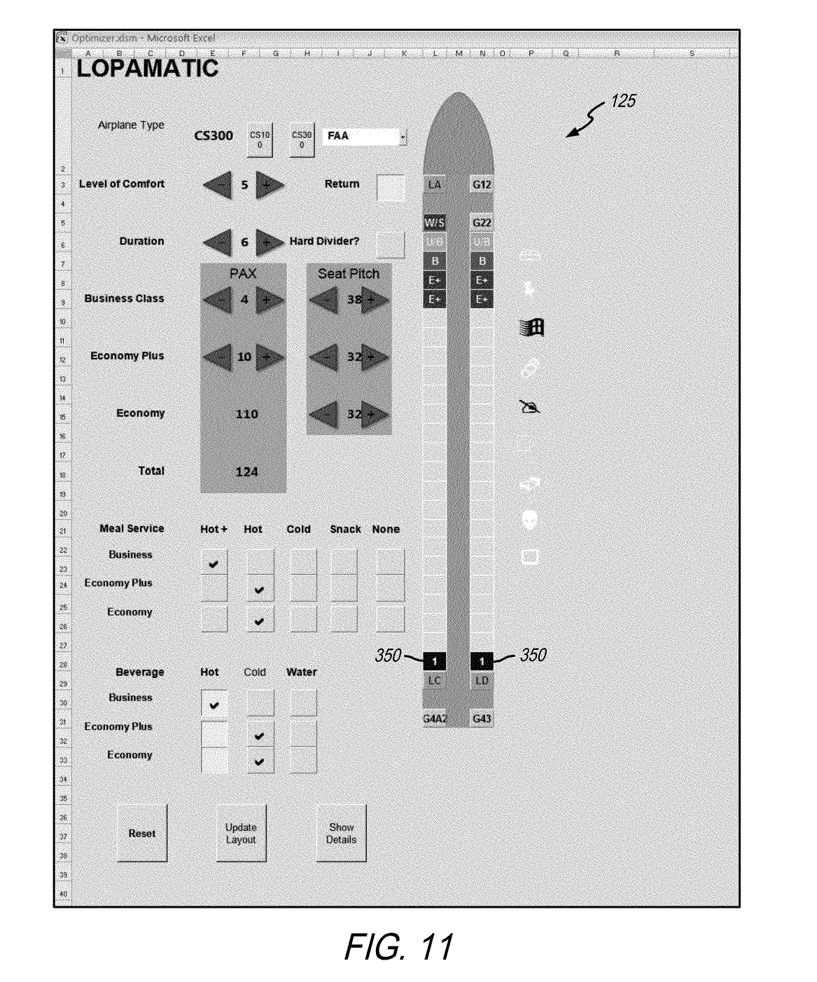

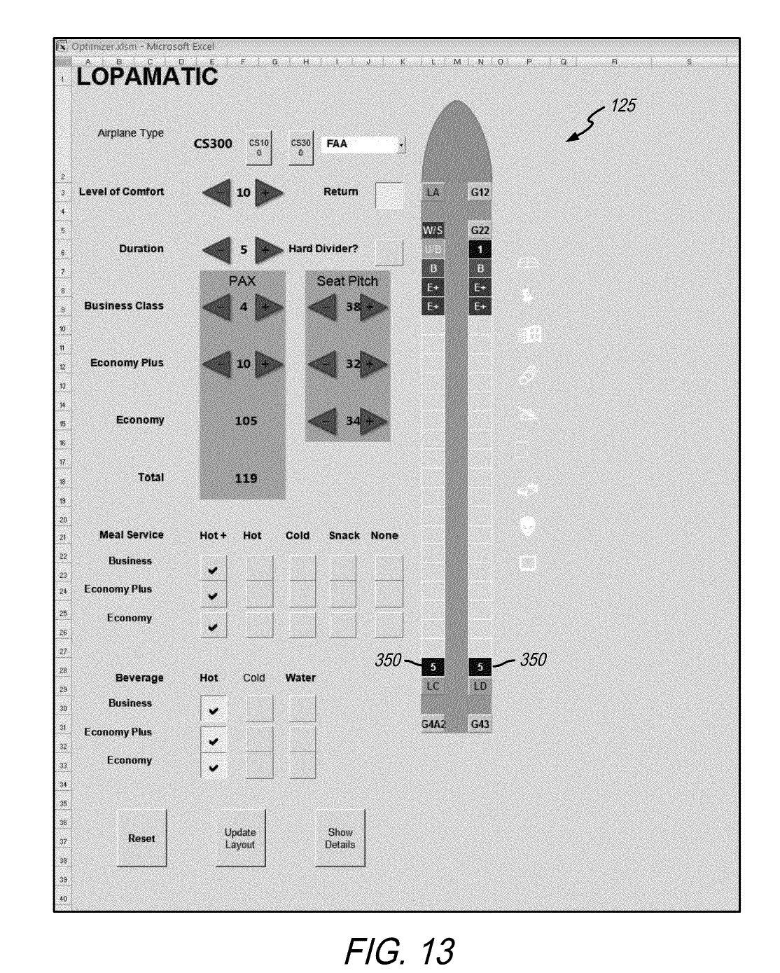

The numerical entry shown at 350 is intended to represent a measurement (units of inches in the present embodiment), of the distance between the forward most (or aft most) seat, and the closest monument. (See further, exemplar measurements 350, at FIGS. 11 and 13.) The measurement 350 changes as a result of user input of the other configuration variables, and it allows the user to “fine tune” a particular layout so as to further maximize the use of interior aircraft space.

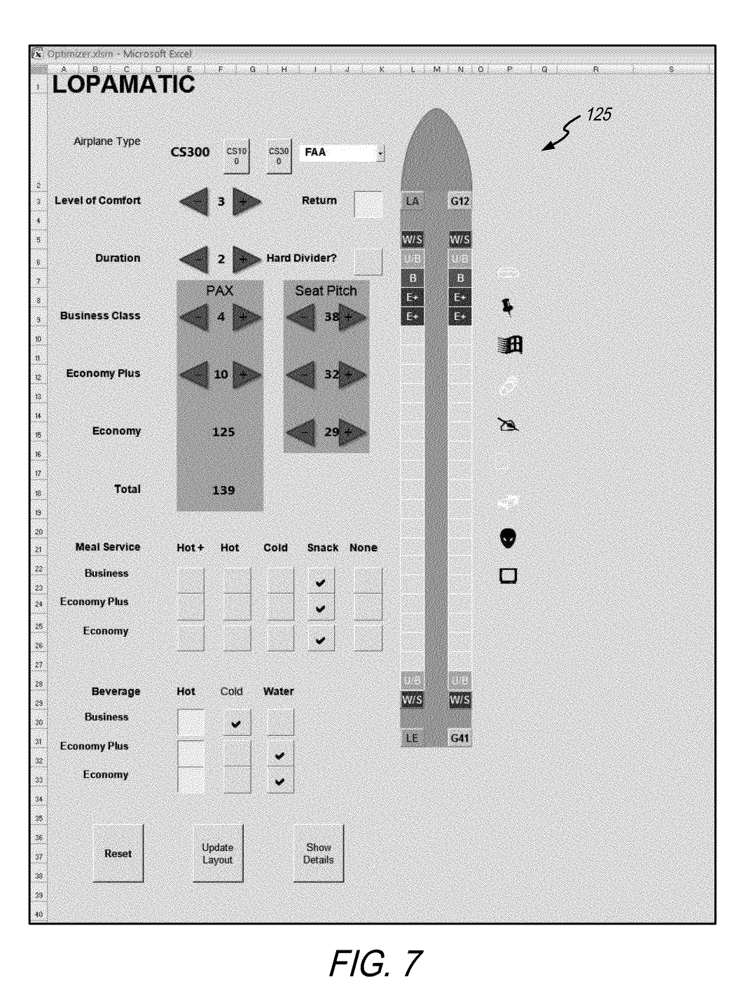

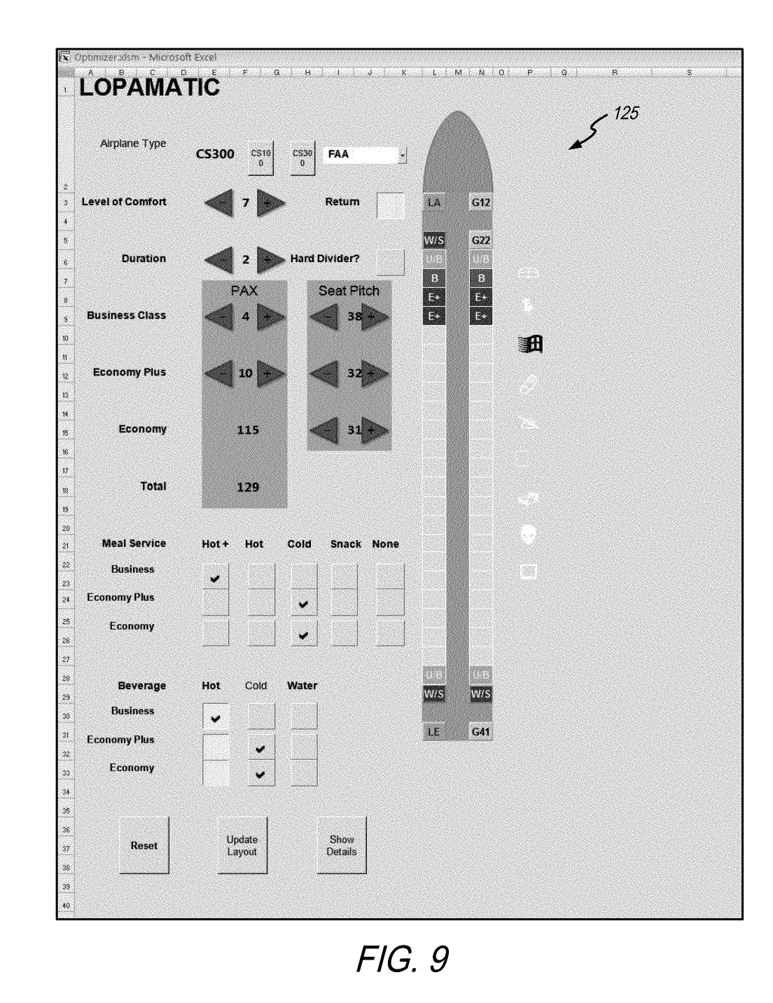

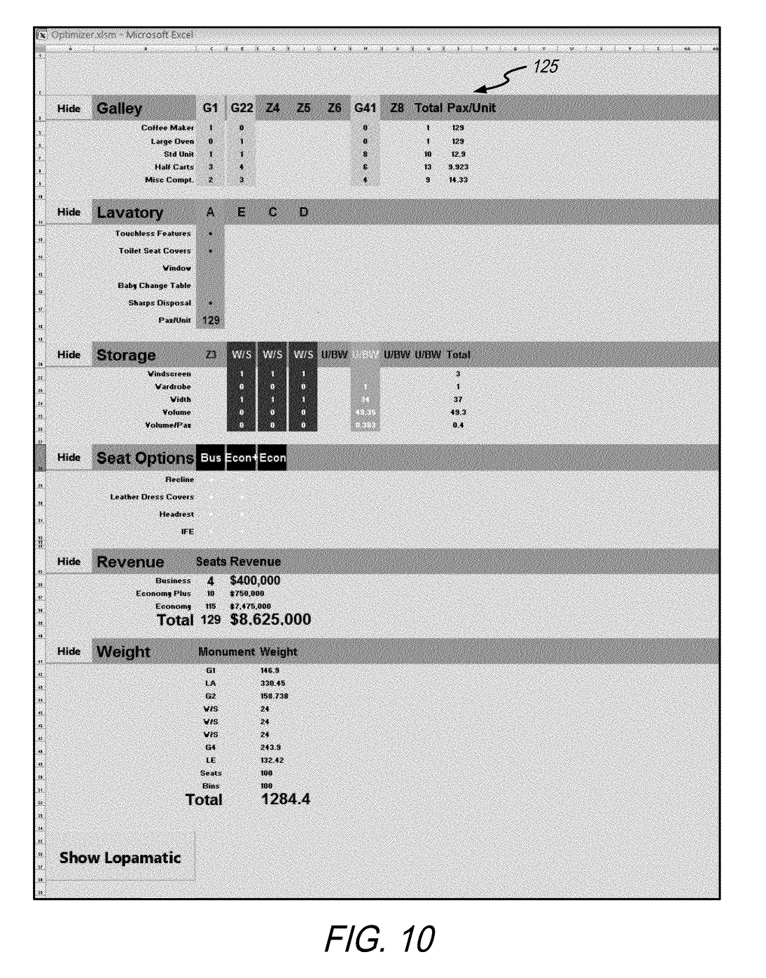

In implementation, referring now to FIGS. 7 through 14, various input scenarios (represented in FIGS. 7, 9, 11, and 13), and various output scenarios corresponding to each respective input scenario (represented in FIGS. 8, 10, 12, and 14) are shown. For example, FIG. 7 depicts an input scenario having a relatively low comfort level selected with a relatively short flight duration. The output for this input scenario is depicted in FIGS. 7 and 8. As can be seen in FIG. 8 (and also in each successive output scenario of FIGS. 10, 12, and 14), an inventory listing specific components needed for each specific layout is presented (from module or step 240B). In contrast to FIG. 7 (where a relatively low comfort level is selected), FIG. 9 shows an input scenario having a relatively high level of comfort/service, and the differences in output for this input scenario, as compared to the input scenario depicted by FIG. 7, can be observed by comparing FIGS. 9 and 10 to FIGS. 7 and 8. Other various input scenarios are shown in FIGS. 11 and 13, and the respective differences in output as among the various scenarios can be observed.

The particular arrangement shown in the figures and described herein is intended to be only exemplary. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims. For example, while the present invention is not limited to performing the input steps or providing input information in any particular order, it is contemplated and intended to be within the scope of the present invention to perform the input steps or providing input information in an order or sequence that might be advantageous. For example (and not by way of limitation), it is intended to be within the scope of the present invention that an aircraft type input may be provided as a first or initial step, as the aircraft type drives the later decisions (both by the system of the present invention and the user) regarding choices and options that need to be selected for other aspects of the aircraft layout. Similarly, it is intended to be within the scope of the present invention that other user inputs, such as level of comfort/service, and/or duration of flight might be an initial or first step (or even an early step, and not necessarily the first step), as again, these (and other such “top level” inputs) drive later decisions made by the system and/or the user. In addition, the level of comfort/service and flight duration can drive any number of layout option variables that are not dependent on specific seating choices.

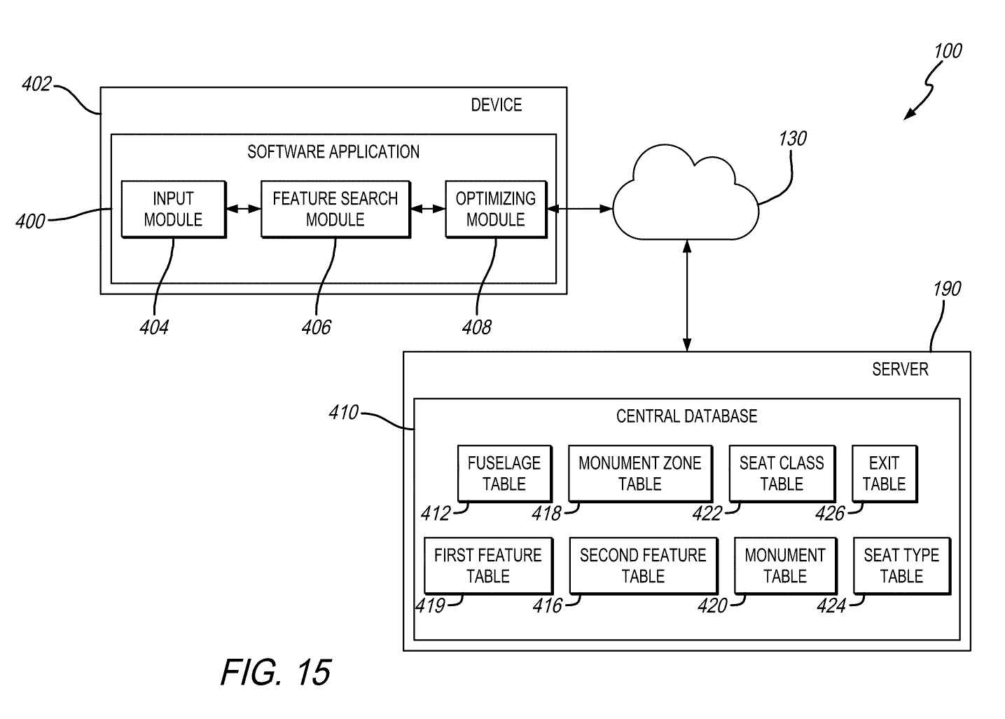

FIG. 15 conceptually illustrates the architecture of a preferred embodiment of the present invention. In a preferred embodiment, there is provided a software application 400 running on a device 402, which is in communication with a server 70 via the network 130. In a preferred embodiment, the software application 400 is a stand-alone application for receiving input data and providing an optimized design layout based on the input data, and runs on a device 402 that uses the Android operating system. However, it will be understood by those of ordinary skill in the art that the software application 400 can be a stand-alone application implemented on a computer or device 402 using iOS, Windows, Windows Phone, Linux, Unix, OS X, or any other operating system, implemented within another application or within any operating system, or implemented within the firmware or hardware of a computer or device 402. Those of ordinary skill in the art will also appreciate that the software application 400 can be provided via a device 402 that is a thin client, such that the software application 400 can run on one or more servers while a user interacts with the software application 400 via a separate device 402 remote from the server(s) 190. Those of ordinary skill in the art will also appreciate that the software application 400 can be provided on a distributed architecture. That is, software application 400 can be segmented such that portions of software application 400 can operate across additional servers or devices.

The input module 404 of a preferred embodiment, shown in FIG. 15, receives, identifies the type of, and interprets input data received via the device 402, input device drivers (such as a touchscreen device driver, an audio device driver, a motion sensor driver, etc.) that are part of the operating system of the device 402, or any other means for a software application to receive input. In some embodiments, the input device drivers translate signals from input devices and/or input sensors of the device 402 into input data that is provided to the input module 404. Such a signal may be generated, for example, in response to one or more user interactions with an input device of the device 402 to indicate a value of a parameter.

The operation of the input module 404 of a preferred embodiment of the present invention is described as follows. In a preferred embodiment, for example, a user might physically interact with a portion of the touchscreen sensor of the device 402 to indicate a desired comfort level. The touchscreen sensor then converts the physical interaction to a signal, and the device driver then converts the signal into input data (e.g., “a tap at coordinate 5:5”). Preferably, the input module 404 then receives the input data and interprets the input data (e.g., “comfort level 7”). Preferably, the input module 404 also receives an input data that indicates a flight duration, which is the value of a flight duration parameter. However, it will be appreciated by those of ordinary skill in the art that the use of input data indicating flight duration and comfort level by input module 404 are merely exemplary and that input module 404 can be configured to receive input data indicative of any other value of a parameter relevant to optimizing the design layout of an aircraft.

In a preferred embodiment, the server 190 includes a central database 410. Preferably, the central database 410 includes one or more of a fuselage table 412, a first feature table 419, a second feature table 416, a monument zone table 418, a monument table 420, a seat class table 422, and a seat type table 424, and an exit table 426.

In a preferred embodiment, the fuselage table 412 stores data related to fuselages (also referred to herein as airframes). In a preferred embodiment, the monument zone table 418 stores data related to monument zones, which are specified zones within a given fuselage within which monuments can be placed. In a preferred embodiment, the monument table 420 stores data related to monuments. In a preferred embodiment, the seat class table 422 stores data related to seat classes, which are classes within a given fuselage within which seats can be placed. In a preferred embodiment, the seat type table 424 stores data related to seat types, which are the types of seats that can be placed within a given seat class. In a preferred embodiment, the exit table 426 stores data related to exit doors.

In a preferred embodiment, the feature tables 419, 416 store various settings of features (feature settings) which affect the design an aircraft interior. Changes to these feature settings may affect the rules for configuration of an aircraft at one or more levels, including the seat class level, monument level, monument zone level, etc. For example, in a preferred embodiment, the first feature table 419 and the second feature table 416 store feature settings for seat pitch and minimum monument width, respectively. Preferably, each seat pitch setting indicates a pitch of seats in a design layout of an aircraft and each minimum monument width setting indicates the minimum width of a monument that can be placed in a design layout of an aircraft. Preferably, each feature table such as the first feature table 419 and second feature table 416 also include data relating a setting to input data as interpreted by the input module 404. Further, as described in more detail below, feature settings are such that changes to the feature setting either affect the LOPA (LOPA-essential feature settings) or do not affect the LOPA (LOPA non-essential feature settings). For example, changes to seat pitch and monument width may both affect a LOPA, and are thus seat pitch and monument width are LOPA-essential features. A change to the material of a headrest, on the other hand, would not affect a LOPA, and thus headrest material is a LOPA non-essential feature.

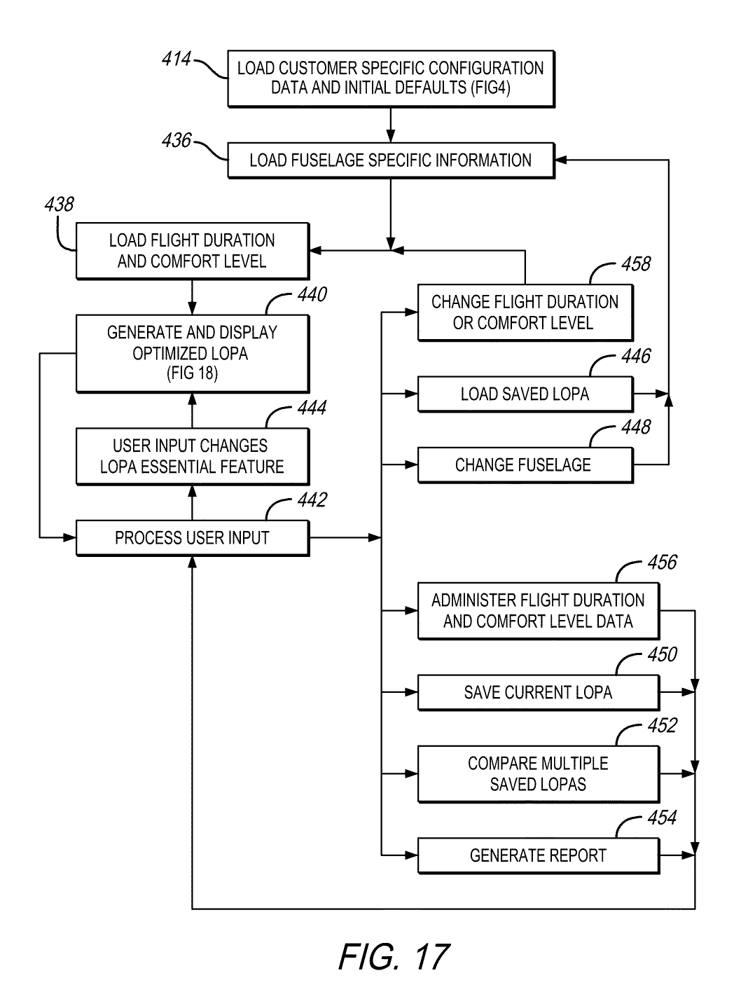

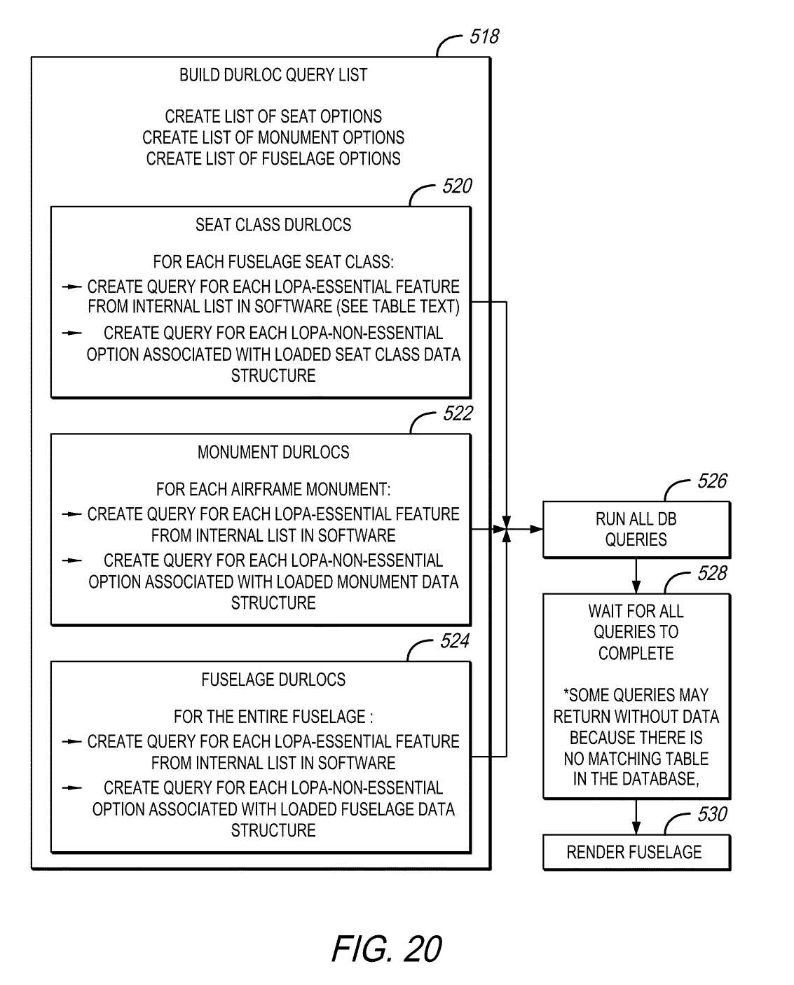

The feature search module 406 of a preferred embodiment, as shown in FIG. 15, searches and extracts data from the feature tables using the input data as interpreted by the input module 404. The operation of the feature search module 406 of a preferred embodiment is provided as follows. In a preferred embodiment, the input module 404 receives and interprets input data indicating a comfort level and flight duration. Preferably, the feature search module then uses the input data interpreted by input module 404, which indicates the value of the first parameter (e.g., comfort level) and the value of the second parameter (e.g., flight duration), to search and extract feature settings from the first feature table (e.g., seat pitch) and the second feature table (e.g., minimum monument width). In a preferred embodiment, the feature search module 406 then makes available to the software application 400 the extracted seat pitch and minimum monument width feature settings. A further description of the feature search module 406 is provided below in the descriptions of FIGS. 17 and 20.

The optimizing module 408 shown in FIG. 15 uses the feature settings extracted by the feature search module 406. A further description of the optimizing module 408 is provided below.

While many of the features have been described as being performed by one module (e.g., the input module 404, the feature search module 406, the optimizing module 408, etc.), those of ordinary skill in the art would recognize that the functions performed by these modules 404, 406, 408 or any other portions of software application 400, server 190, central database 410, or any other software-implemented module or functionality described here can be split up into multiple modules. Similarly, the functions described as being performed by multiple different modules might be performed by a single module in some embodiments.

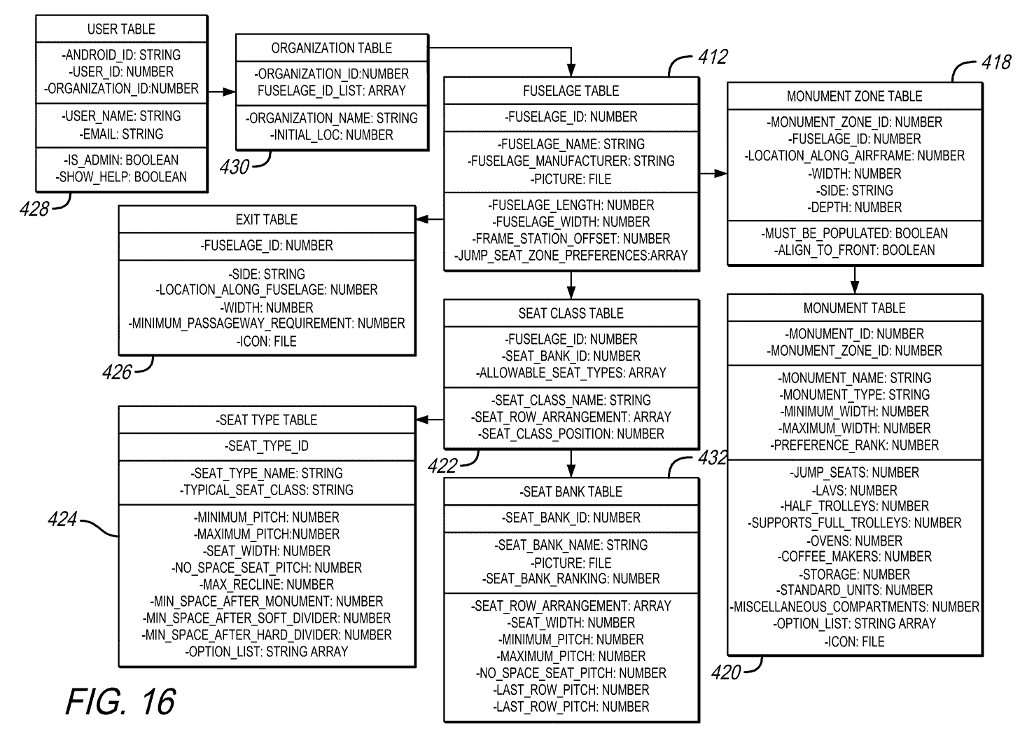

FIG. 16 is a diagram depicting the tables of a central database 410 in a preferred embodiment. In a preferred embodiment, as shown in FIG. 16, the central database 410 includes a user table 428 and organization table 430. Preferably, the user table 428 stores a user ID and user name identifying a user, an organization ID associating a user with an organization, a flag indicating whether a user is an administrator, a device identifier, and a flag indicating whether a help screen should be displayed by the software application 400. In a preferred embodiment, the organization table 430 stores an organization ID for identifying an organization, a fuselage ID list, which lists the fuselages associated with an organization, the name of the organization, and the initial level of comfort, which is a default value. Preferably, the user table 428 and organization table 430 are used by the software application 400 to load configuration data specific to a user and organization, respectively, as further described below.

In a preferred embodiment, the fuselage table 412 stores data such as a fuselage length, fuselage width, frame station offset, and jump seat zone preferences. However, it will be understood by those of ordinary skill in the art that the fuselage table 412 can store any data related to a fuselage and relevant to configuring the design layout of an aircraft.

In a preferred embodiment, the monument zone table 418 stores data indicating any fuselages associated with a monument zone, whether a monument zone may optionally be left empty, whether a monument in the monument zone should be aligned to the front or back of the monument zone, the location along the airframe for that monument zone, the width and depth of the monument zone, and the side of the airframe for the monument zone, among other things. However, it will be understood by those of ordinary skill in the art that the monument zone table 418 can store any data related to a monument zone and relevant to configuring the design layout of an aircraft.

In a preferred embodiment, the monument table 420 stores data indicating the monument zone in which a given monument is located, the type of the monument, the minimum allowable width for the monument, the maximum width of the monument, the monument name, the number of allowable jump seats, the number of lavatories, the number of half trolleys, whether the monument can fit full trolleys, the number of ovens, the number of coffee makers, the number of standard units, the number of miscellaneous compartments, a monument ranking, and a list of boolean options, changes to which would not affect a LOPA (i.e., boolean options that are “LOPA non-essential”). However, it will be understood by those of ordinary skill in the art that the monument table 420 can store any data related to a monument and relevant to configuring the design layout of an aircraft.

In a preferred embodiment, the seat class table 422 stores data indicating any fuselages associated with a seat class, the preferred seat class name, whether the seat class should be used by default, the seat row arrangement for that seat class, and the seat class position ranking (front-to-back of the plane). Thus, preferably, the seat class table stores all information about seats not related to physical specifications for the seats. In a preferred embodiment, seat classes may include, for example, first class, business class, and economy class seat classes for a given fuselage (assuming that the fuselage supports these seat classes). However, it will be understood by those of ordinary skill in the art that a seat class can be any section of seats within a fuselage.

In a preferred embodiment, the seat type table 424 stores data indicating the physical seat name, the seat width, the minimum seat pitch, the maximum seat pitch, the seat length, the last row seat pitch, the minimum space after dividers and monuments, the maximum recline, and a list of LOPA non-essential feature settings or options, as further described below. However, it will be understood by those of ordinary skill in the art that the seat type table 424 can store any data related to a seat type and relevant to configuring the design layout of an aircraft.

In a preferred embodiment, the exit table 426 stores data indicating the side of the fuselage for the exit, the location along the airframe for the exit, the exit width, and the minimum passageway requirement (used for emergency exits). However, it will be understood by those of ordinary skill in the art that the exit table 426 can store any data related to an exit and relevant to configuring the design layout of an aircraft. Preferably, the central database 410 is a relational database system and the user table 428, organization table 430, fuselage table 412, first feature table 419, second feature table 416, monument zone table 418, monument table 420, seat class table 422, seat type table 424, seat bank table 432, and exit table 426 are tables within the central database 410. However, it will be understood by those of ordinary skill in the art that these tables 428, 430, 412, 419, 416, 418, 420, 422, 424, 432, 426 and any other data structures referred to herein can be standalone data structures, database tables, databases, data storage, or any other physical apparatus or software-implemented structures, whether implemented on a volatile or nonvolatile medium, for storing data. Further, it will be appreciated by those of ordinary skill in the art that in some embodiments, the tables 428, 430, 412, 419, 416, 418, 420, 422, 424, 432, 426 are implemented in one physical storage while, in other embodiments, the tables 428, 430, 412, 419, 416, 418, 420, 422, 424, 432, 426 are implemented on separate physical storages. Still, in some embodiments, some or all of the tables 428, 430, 412, 419, 416, 418, 420, 422, 424, 432, 426 are implemented across several physical storages.

FIG. 17 is a flow chart illustrating the basic operation of a preferred embodiment of the present invention. In a preferred embodiment, when the software application 400 is first run, it loads user or customer specific configuration data and/or initial default values 414 into a data structure. These customer specific configuration data and/or initial default values include, for example, a default fuselage or airframe and related data. In a preferred embodiment, information specific to that fuselage or airframe, such as the data stored in the monument zone table 418, seat class table 422, exit table 426, and other related tables is then loaded 436 into a data structure. In a preferred embodiment, feature settings or grouped presets of feature settings specific to a default flight duration and level of comfort (also referred to herein as comfort level) (“DurLOCs”) are then loaded 438 from feature tables into a data structure, along with other feature settings which are not affected by flight duration or comfort level. The software application 400 then uses the loaded feature settings and default monuments and seat locations to calculate and display an initial optimal LOPA 440. Preferably, the initial LOPA is rendered such that it is a scaled 2D representation of the airplane interior. In a preferred embodiment, as it renders the LOPA, the software application 400 also waits for user input. In another preferred embodiment, the software application 400 waits for user input after the LOPA is rendered. Preferably, information relevant to user decisions is placed adjacent to or within the LOPA displayed by the software application 400. For example, in a preferred embodiment, monument names are placed in or near the rendered monuments, unused space is labeled to help a user identify potential optimizations, and the length of variable-sized monuments is shown. Preferably, this information may be changed depending on the configuration tab displayed by the software application 400 the user is working within. For example, in a preferred embodiment, the names of galleys might be displayed when the user is working within the catering tab, whereas the names of wardrobes and their sizes might be displayed when the user is working within the wardrobe tab.

The software application 400 then processes user input 442 which can indicate, for example, requests to change feature settings such as seat pitch, seat divider locations, seat divider type, number of seat classes, number of seats in each seat class, number of rows of seats in a class with reduced seat pitch, minimum allowable recline for the last seat in a seating section, catering requirements (number of hot and cold items per passenger, number of snacks per passenger, number of hot drinks per passenger, number of cold drinks per passenger), number of meals per half trolley for a seating section, type of seat for a seating section, number of passenger per lavatory, number of passengers per coffee maker, number of passenger per oven, number of passengers per standard unit, monuments that must be forced to be present, and monuments that must have a minimum size.

When a user input indicates a change to a feature setting that could affect other parameters of the LOPA (“LOPA-essential” features), the software application 400 will automatically update the LOPA 444.

Other user input may indicate a request to: load a saved LOPA 446, change the airframe 448, save the current LOPA 450, compare multiple saved LOPAs 452, or generate a detailed report for the currently loaded LOPA 454. In a preferred embodiment, the report generated at step 454 details all monument and seat class selections including specific locations and any selected optional features. Preferably, the report also includes a rendering of the LOPA and a detailed textual accompaniment. In response to a user input indicating a change to a new flight duration or comfort level 458, the software application 400 loads the new flight duration and/or comfort level settings into the data structure 438 and then recalculates and displays a new optimized LOPA 440. The software application 400 also allows a user with administrative privileges to administer the duration and level of comfort settings 400 in the central database 410.

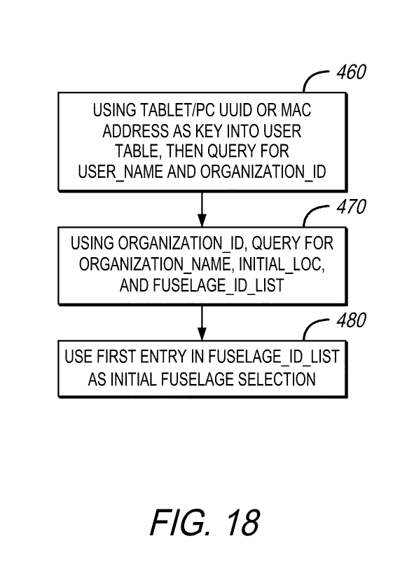

FIG. 18 is a flow chart demonstrating the subsection of the software application 400 that loads customer specific configuration data and initial defaults, as shown in FIG. 17 414. In a preferred embodiment, the customer specific configuration data and initial defaults are loaded from the user table 428, 414. Preferably, the software application 400 extracts customer-specific configuration data and initial defaults from the user table 428 by querying the user table 428 using a Unique User ID (UUID), MAC address, or other unique identifier of the device 402 as a key 460. However, it will be understood by those of ordinary skill in the art that the software application 400 can use a login and/or password, biometric authentication, or any other means of identifying a user. In a preferred embodiment, the central database 410 is implemented using the Parse service. Preferably, the query of the user table 428 returns a user name and an organization ID from the database 401.

In a preferred embodiment, the organization ID is then used to query the organization table 430 for the organization name, initial comfort level, and a fuselage ID list 470. Preferably, the initial comfort level is assigned when a new organization ID is added to the database. It should reflect the typical level of comfort utilized by that carrier. By way of example, a budget airline might assign a low default comfort level, whereas a luxury airline would be assigned a high default level of comfort. In a preferred embodiment, the fuselage ID list contains a list of all fuselage (airframe) IDs utilized by the organization using the software application 400. Preferably, the first entry in the fuselage ID list is the default fuselage that will be loaded at program start time for that carrier 480.

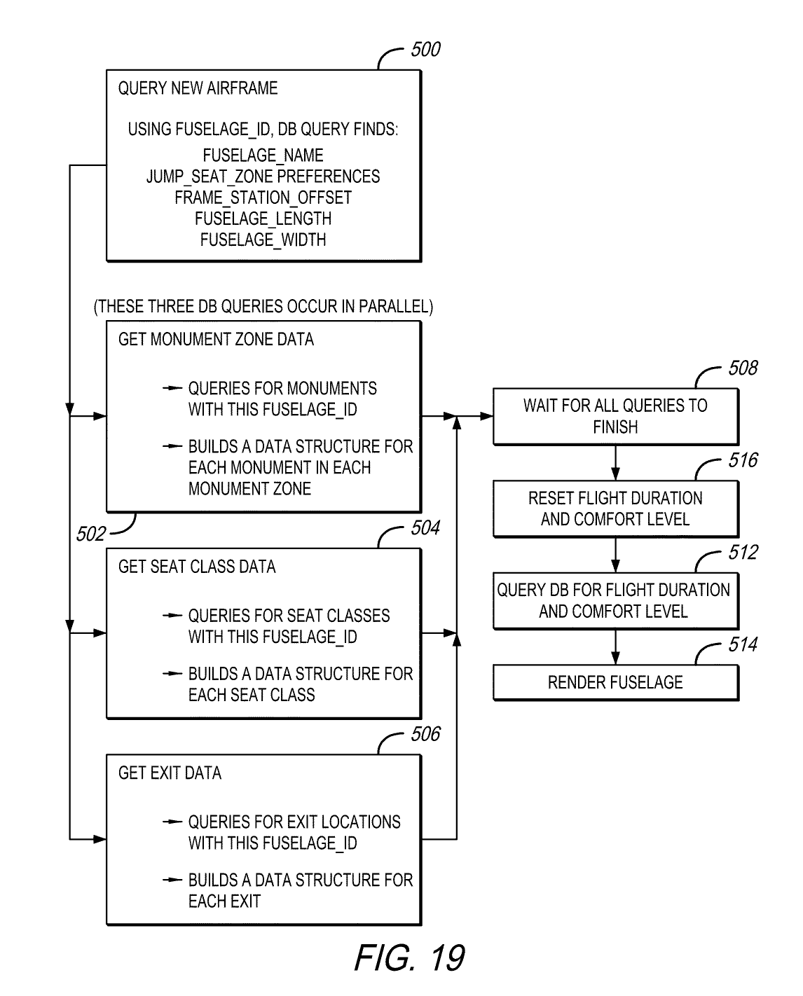

FIG. 19 is a flow chart detailing the interactions between the software application 400 and the central database 410 are performed when a new fuselage is selected by a user. Preferably, the depicted process is also performed when a fuselage is reloaded by the user and when the software application 400 is first executed.

As shown in FIGS. 18 and 19, in a preferred embodiment, a fuselage_id list is made available to the application 470, 480 through a database query 500. In a preferred embodiment, the software application 400 uses a fuselage_id from the fuselage_id list to perform a query on the fuselage table, and associated data is returned. In a preferred embodiment, the associated data includes a fuselage name, preferred monument zone placements for jump seats, offset information for the first frame station relative to the start of the airframe (which the software application 400 uses to define the “zero,” or starting, location for attaching monuments), and the fuselage length and width (which the software application (400) uses to render the outline of the airframe in the correct ratio).

In a preferred embodiment, the software application makes three additional queries based on the fuselage_id. Preferably, these queries are made in parallel, in order to minimize the transaction time. However, it will be understood by those of ordinary skill in the art that these queries can also be made sequentially or in any order. In a preferred embodiment, these queries return data related to monuments 502, seat classes 504, and exit location data 506.

As shown in FIG. 16 and described above, monument data is stored in the monument zone table 418 with a field that relates each monument zone to a fuselage_id. Therefore, in a preferred embodiment, the software application 400 query based on fuselage_id returns a plurality of monument zones associated with a particular fuselage.

In a preferred embodiment, each monument zone in the queried monument zone table 418 is identified by monument_zone_id, and associated with a particular fuselage_id, and includes information on whether that monument zone may optionally be left empty, whether the monument in the monument zone should be aligned to the front or back of the monument zone, the location along the airframe for that monument zone, the width and depth of the monument zone, and the side of the airframe for that monument zone. Each monument zone is in turn associated with a plurality of monuments stored in the monument table 420 that may be placed in that monument zone. In a preferred embodiment, the software application 400 performs a query of the monument zone table 418 and monument table 420 to extract monument data, which is then loaded into a local data structure 502. Likewise, in a preferred embodiment, the software application 400 performs a query of the seat class table 422, seat type table 424 and seat bank table 432, 504 and stores the extracted seat class data and associated physical seats into a local data structure. Preferably, the software application performs a query of the exit table and extracts data related to exit doors related to the selected fuselage and stores that extracted data in a local data structure 506.

In a preferred embodiment, after the queries for the monument zones 502, seat classes 504, and exits 506 receive replies from the central database 508, the software application 400 resets the flight duration and comfort level settings to a default value 516. In a preferred embodiment, the default settings for flight duration and comfort level are one hour and level one, respectively. However, it will be understood by those of ordinary skill in the art that the use of these default values are merely exemplary. Following the reset of the flight duration and comfort level settings, the software application 400 queries the central database 410 for flight duration and comfort level settings 512 as shown in FIG. 20 and further described below. The fuselage is then rendered 514 using all of the downloaded information as described more fully below.

FIG. 20 is a flow chart detailing the interactions between the software application 400 and the central database 410 of a preferred embodiment that occur when a new flight duration and/or comfort level setting are selected by a user. Preferably, the process 518 also occurs when a new fuselage is selected, when a fuselage is reloaded, and when the software application 400 is first executed. In a preferred embodiment, flight duration and level of comfort settings (“DurLOCs”) may be created for seat class-specific settings, for monument-specific settings, and for airframe-wide settings 518. Preferably, a list of DurLOCs is automatically generated 518 by the software application 400 based on the current airframe before the software application 400 creates DurLOC queries (as further described below).

In a preferred embodiment, DurLOC queries are queries created by the software application 400 and executed on the central database 410 to retrieve DurLOCs based on either a user-provided or default flight duration and level of comfort. Preferably, the software application 400 uses an internal list of DurLOCs to create DurLOC queries for LOPA-essential features. However, it will be appreciated by those of ordinary skill in the art that DurLOC queries can be created based on data stored in any internal or external data storage or data structure. Seat class DurLOC queries are DurLOC queries that retrieve certain feature settings (“DurLOC feature settings”) relevant to seat class and are created for each seat class in a given fuselage 520. By way of example, a fuselage with both business class and economy class seat classes would have a separate set of DurLOC feature settings for each of those seat classes. In a preferred embodiment, for each seat class, the software application 400 creates a query for each LOPA-essential feature and for each LOPA non-essential feature. Therefore, the total number of DurLOC seat class queries is the product of the number of supported seat classes multiplied by the number of features. The table below shows the DurLOC features of a preferred embodiment and indicates whether each DurLOC feature is LOPA-essential.

| Feature: | LOPA essential? |
|---|---|
| Seat class enabled by default | Yes |
| Seat pitch | Yes |
| Seat hard setback distance | Yes |
| Seat soft setback distance | Yes |
| Hot meals per pax for seat class | Yes |
| Cold meals per pax for seat class | Yes |
| Snacks per pax for seat class | Yes |
| Alcoholic drinks per pax for seat class | Yes |
| Hot drinks per pax for seat class | Yes |
| Soft drinks per pax for seat class | Yes |
| Seat type for seat class | Yes |
| Minimum monument width | Yes |
| Seats support recline? Y/N | Yes |
| Seats are leather? Y/N | No |
| Seats have headrest? Y/N | No |
| Seat have in-flight entertainment? Y/N | No |
| Lav has sharps disposal? Y/N | No |
| Lav has toilet seat covers? Y/N | No |
| Lav has window? Y/N | No |
| Lav has baby changing station? Y/N | No |
| Lav supports touchless operation? Y/N | No |

Similarly, in a preferred embodiment, the software application 400 creates DurLOC queries for each monument supported by the fuselage 522. Preferably, for each supported monument, a DurLOC query is created for each LOPA-essential feature and each LOPA non-essential feature. Preferably, the monument DurLOC queries Therefore, in a preferred embodiment, the total number of DurLOC monument queries is the product of the number of supported monuments multiplied by the number of features.

In a preferred embodiment, the software application 400 fuselage DurLOCs 524 are the list of LOPA-essential and LOPA non-essential features specific to a selected fuselage.

In a preferred embodiment, after all of the DurLOC queries are generated, they are executed on the central database 410, 526. Preferably, a DurLOC feature has a unique feature name, a flight duration, and a level of comfort. In a preferred embodiment, each unique feature name is a table entry in a feature table, and the flight duration and level of comfort are combined to create a key that is used to query the feature table. Thus, each DurLOC query is executed on a different feature table and returns a result that depends on the key generated from the flight duration and comfort level. In a preferred embodiment, all DurLOC queries are sent in parallel, in order to minimize the transaction time. Preferably, the software application 400 waits for all DurLOC queries to complete before proceeding 528. In a preferred embodiment, it is possible that some DurLOC queries may not return any data, for example, if not all DurLOC table entries have been populated in the central database 410. In this case, the software application 400 defaults to a value that has already been set for that feature or setting. Thus, in a preferred embodiment, only DurLOC table entries that are relevant need to be populated, and missing DurLOC table entries will not cause an erroneous result. Preferably, all of the returned DurLOC table entries are stored locally within the software application 400. In a preferred embodiment, the data related to LOPA-essential feature is updated within the software application 400 such that the subsequent rendering cycle will utilize the changed values. Preferably, a rendering cycle is forced when the DurLOC table entries are returned, and the fuselage is rendered to account for any changes that may have occurred 530.

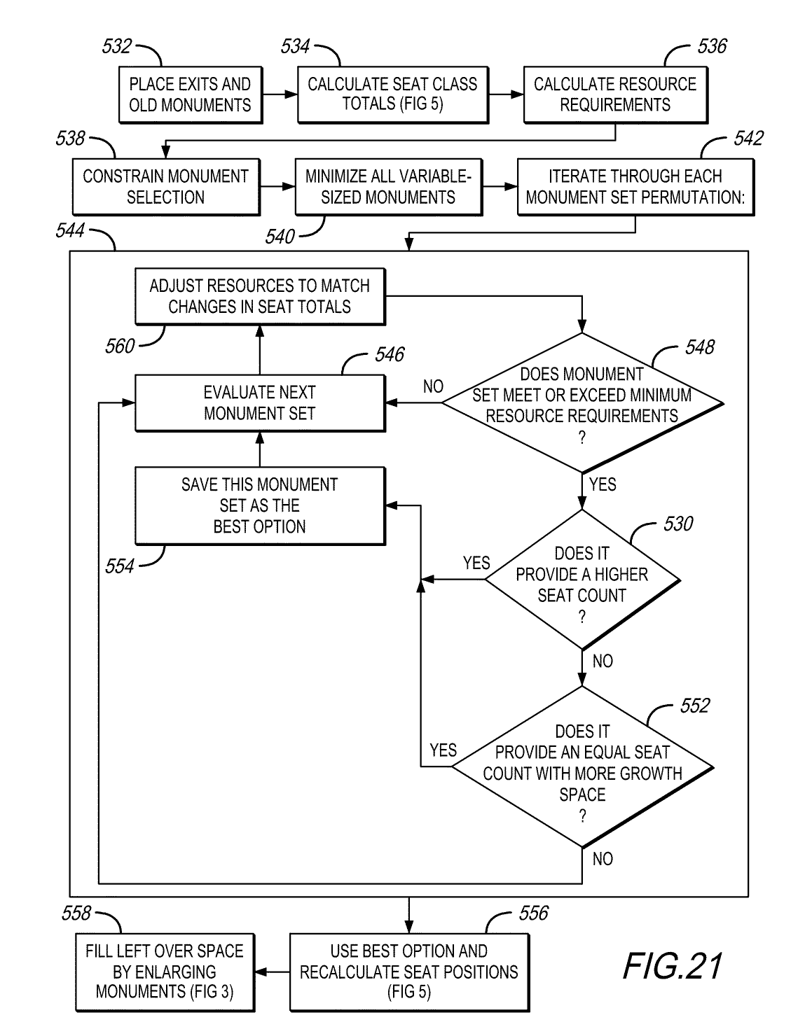

FIG. 21 is a flow chart that details the algorithm performed by the software application 400 that generates and displays an optimized LOPA, as shown in FIG. 17 440. First, in a preferred embodiment, the exit locations and previously loaded monuments must be placed 532 within the loaded airframe. Preferably, if this is the first time the algorithm is run, the monuments are selected and placed using a default setting. Otherwise, if the algorithm has previously been run, the monuments used the last time the algorithm was run are used. In a preferred embodiment, once the monuments are placed within the airframe, the number of seats for each active seat class is calculated based on the non-monument space 534. Preferably, resource requirements for the airframe are then calculated 536. Resource requirements may include, for example, the number of lavatories and/or ovens required. In a preferred embodiment, the resource requirements for an airframe are calculated based on feature settings including those related to comfort level and flight duration, number of passengers, and catering requirements (e.g., feature settings affecting the number of hot and cold meals, hot and cold drinks, and snacks per passenger, as well as seat class rules affecting the number of ovens and coffee makers per passenger). For example, the number of passengers that can be served by each lavatory on an airframe may be higher on a short duration flight, as fewer passengers will need to use the lavatory for the duration of the flight. Likewise, the number of ovens required for a flight may depend on whether hot meals are being served to some or all passenger classes. However, it will be appreciated by those of ordinary skill in the art that the calculation of resource requirements based on catering requirements, feature settings, and number of passengers is merely exemplary, and that resource requirements may be calculated based on additional factors, predetermined by an administrator, or set by a user.

In a preferred embodiment, the selection of monuments for placement in the fuselage are then constrained 538. In a preferred embodiment, the resource requirements can limit the monuments that can be placed in the fuselage. For example, in a preferred embodiment, the number of lavatories, number of ovens, number of coffee makers, number of standard units, and number of half or full trolleys can affect the placement of monuments. Preferably, a user placement of a certain monument can affect the placement of other monuments. For example, if a user of a preferred embodiment places a certain monument (for example, to maintain compatibility with an existing fuselage), the optimizing module 408 can automatically place the remaining monuments in the fuselage subject to constraints. By way of more specific example, in a preferred embodiment, a user may want to place a wardrobe near the business class section. The wardrobe may be constrained to a certain minimum size. In a preferred embodiment, the specific placement of the wardrobe might then preclude the optimizing module 408 from automatically placing certain alternative monuments in place of the wardrobe in the same monument zone.

In a preferred embodiment, the software application 400 then reduces all variable-size monuments to a local minimum size 540 that is calculated and stored by the software application 400. As shown in FIGS. 15 and 16, the absolute minimum size of a monument is stored in the monument table 420. In a preferred embodiment, the local minimum size for a monument, calculated and stored by the software application 400, is calculated using the absolute minimum size as a default value, but can be further constrained (i.e., higher than the absolute minimum) depending on the feature settings. By way of example, a variable sized lavatory might have a local minimum size that is larger than the absolute minimum size if a user has selected a relatively high comfort level (because a small lavatory would be inconsistent with a high comfort level).

After minimizing all variable-sized monuments (540), the software application 400 then has available to it at least one monument set having monuments that are reduced to their minimum size. A monument set is a specific combination or permutation of monuments that can be placed in the monument zone(s) of the airframe. A monument set is one example of an aircraft component layout configuration. In a preferred embodiment, the software application 400 first analyzes monument sets, and then places seats into a selected monument set. However, those of ordinary skill in the art will appreciate that the software application 400 can also find and select seats or any other aircraft component first. Some monument zones may be empty, and others may require a monument. By way of example, if a fuselage has four monument zones, and each monument zone has five monuments that can be placed in the monument zone, then the total number of monument set combinations or permutations would be 5⁴=625.

In a preferred embodiment, the optimizing module 408 then iterates through each monument set 542 and performs an iterative analysis 544. In the iterative analysis, the optimizing module 408 first evaluates each monument set 546. Monument sets can differ in the number and minimum size of the monuments in the set. Therefore, selecting a different monument set could change the total remaining space available for passenger seats, which in turn could affect the resource requirements, as certain resource requirements depend on the number of passengers in each seating class. Thus, the software application 400 recalculates the resource requirements whenever the seat totals change for a new monument set 560.

The optimizing module 408 then confirms whether the monument set meets the minimum resource requirements 548, (e.g., by confirming that a sufficient number of lavatories, coffee makers, ovens, trolleys, and storage units are present). The monument sets eligible for placement in the airframe can be further constrained by requiring that resources be located close to the seat class being served. For example, the software application 400 might enforce a requirement that ovens and trolleys be located near the business class rather than at the far end of the plane.

In a preferred embodiment, if the optimizing module 408 determines that a monument set meets or exceeds the minimum resource requirements 548, then the optimizing module 408 evaluates the impact of the monument set on seat count 530. Monuments that can grow in the direction of a seat class can impact the seat count. For these monuments, the software application 400 determines the seat pitch of the adjacent seat class and the current amount of available (empty) space. If a monument can fit in the empty space without interfering with seats, then there is no change to seat count. In a preferred embodiment, the optimizing module 408 flags when a seat row (or two) must be removed to make space. Likewise, preferably, the optimizing module 408 also flags when a seat row can be added. Preferably, the optimizing module 408 utilizes these flagged values to determine the overall impact of the monument set and then preserve as potentially optimal the monument sets that allow for the highest number of seats (maximal seat count). The software application 400 may also use a weighted value to account for the relative value of higher class seating. For example, one additional first class seat might be more desirable than three economy seats, and therefore the optimizing module 408 of a preferred embodiment would preserve a monument set providing for one first class seat rather than one providing three economy seats.

In a preferred embodiment, if the optimizing module 408 determines and preserves more than one monument set that provides the same maximal seat count (or other weighted priority value based on seat placement) 530, then for each of such monument sets, the optimizing module 408 calculates the amount of unused space in the airframe (growth space) and evaluates monuments sets based on this factor 552. In a preferred embodiment, growth space (also known as free space, or the free space in a configuration zone) is maximized. Preferably, the optimizing module 408 then preserves those monument sets and further performs the optimization calculation on those preserved monument sets. This unused space is desirable because it can be used, for example, to expand wardrobes, lavatories, lower pitch row seats, final seat row recline, and divider spacing 552.

In a preferred embodiment, there may be more than one monument set that provides an identical maximal seat count (or other weighted priority based on seat placement) and also provides identical remaining growth space. Preferably, the optimizing module 408 then further evaluates monument sets by weighing relative monument ranking scores. In a preferred embodiment, a monument ranking may be stored in the central database 410, and the optimizing module prefers the monument sets with the highest total monument ranking scores. In another preferred embodiment, the monument ranking score may be used to override seat growth space or even seat count, such that a particular monument set will be selected even if it results in a monument set that does not provide the maximum amount of seat count or unused space.

In a preferred embodiment, after evaluating each of the monument sets according to the steps described above 548, 530, 552, the optimizing module 408 then selects a best monument set based on those evaluations 556. Preferably, if more than one of such monument sets exists, any of them may be used. In a preferred embodiment, the optimizing module 408 then uses the selected best monument set to recalculate the seat positions 556. Finally, in a preferred embodiment, the optimizing module 408 uses any remaining space by expanding all variable sized monuments (e.g., lavatories, wardrobes, lower pitch seat rows, final row seat recline limits, divider placements, etc.) 558.

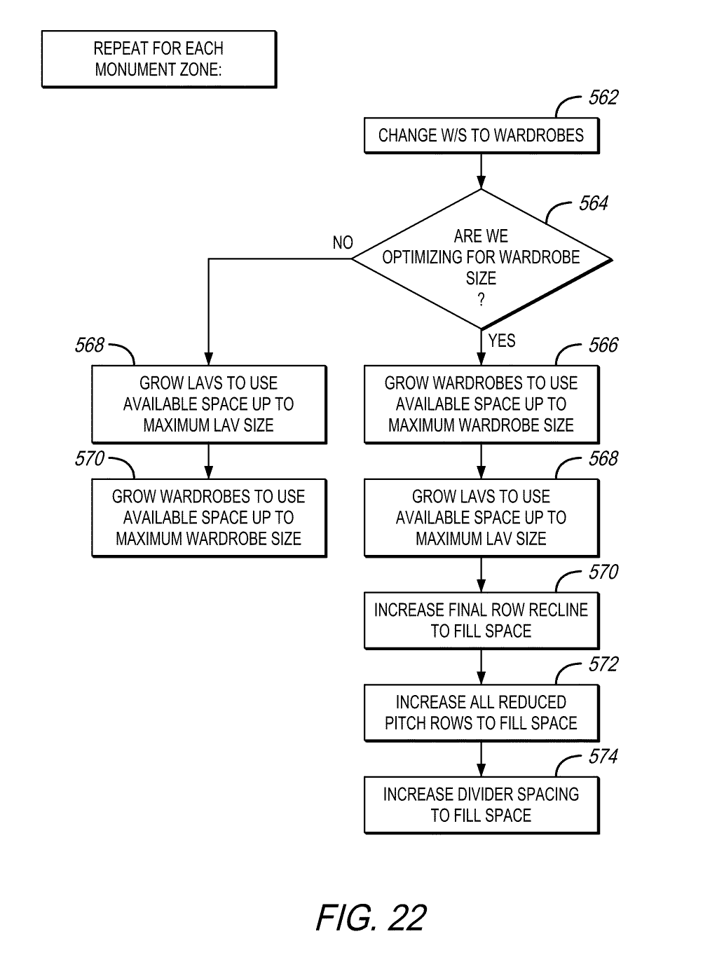

FIG. 22 is a flow chart that details the subsection of the software application 400 that fills left over space by enlarging certain monuments shown in FIG. 21 558. In a preferred embodiment, each monument zone must be evaluated and the free space in that monument zone must be allocated. A configuration zone refers to the area between two immovable components that may house seats or variable sized monuments. Preferably, all seat rows with a reduced pitch can be expanded to increase comfort for passengers sitting in that row 572. In a preferred embodiment, the optimizing module 408 can also relax the limited final row recline limitation, if any, to offer more comfort for the final row passenger 570. Seat compromise is the amount in which seating is affected, e.g., by having a reduced pitch or recline limitations. Thus, in a preferred embodiment, the software application 400 aims to preserve the monument sets having the least seat compromise. Preferably, a windscreen can be placed between the exit door and the first or last seat of a seat class. However, if the seat pitch for that seat class results in extra space, the optimizing module 408 replaces the windscreen with a variable sized wardrobe 562. Thus, when filling any empty space, the software application 400 checks for the presence of windscreen monuments and replaces them with wardrobes where possible. By way of example, a wardrobe will often have a minimum size (typically 8 inches), and so the transformation from windscreen with a minimum size of 1 inch to a wardrobe may only occur when there are at least 7 inches of additional unused space. In a preferred embodiment, once all windscreens are converted, any other variable sized monuments (e.g., lavatories) are then adjusted to maximally utilize remaining space 568. However, in a preferred embodiment, the optimizing module 408 can maximize wardrobe size before maximizing monument size 564. Finally, divider spacing may be increased 574.

It will be understood by those of ordinary skill in the art that the order in which empty space is assigned by optimizing module 408 may be changed, or that empty space can be allocated in parallel and split in a predetermined ratio between multiple uses of the empty space. For example, in another preferred embodiment of the present invention, final row recline may be increased only after reduced pitched rows are increased. In another preferred embodiment, the specific ordering of space assignment can be user-defined.

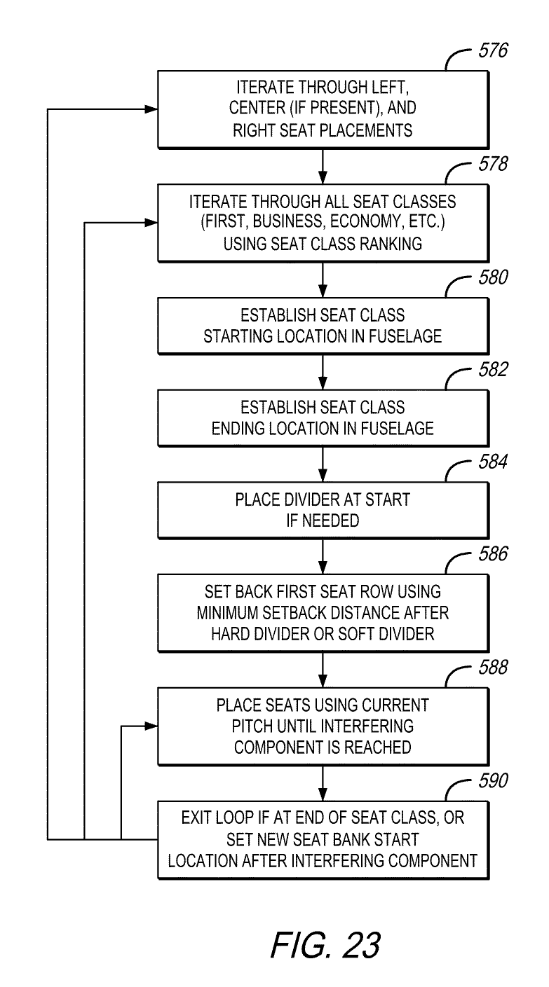

FIG. 23 is a flow chart that details the algorithm performed by the optimizing module 408 to place seats within an airframe for each seat class and subsequently calculate the total number of seats in each seat class, in accordance with a best option monument set, as shown in FIG. 21 556. In a preferred embodiment, the left, right and (if present) center seating sections are each handled in turn 576. Preferably, each seat class (First, Business, Economy, etc. is likewise handled in turn 578. In a preferred embodiment, for each seat class, a starting location is determined 580. Preferably, this is the front of the plane if the first seat class is being processed, otherwise it is the location after the end of the previous seat class. In a preferred embodiment, the optimizing module 408 also determines the end of the seat class 586. Preferably, the optimizing module 408 calculates the end of the seat class as the location that is the location of the start of the seat class, plus the length of the seat class. In a preferred embodiment, by default, all seat classes start with a length that is an equal fraction of the airframe. For example, if the fuselage has three seat classes, each seat class will have a length equal to one third of the airframe. In other preferred embodiments, the software application 400 can use other means of establishing an initial seat class length, such as, for example, using a default value that has been predefined for the airframe in question.

In a preferred embodiment, a divider may be placed at the start of each seat class 584. Preferably, the initial presence and type of divider (soft or hard) will also be assigned a default value, optionally on an airframe specific basis. In a preferred embodiment, the first seat is placed some distance after the initial divider (if present) 586. Preferably, this offset is determined by FAA requirements, and is part of the default data associated with the airframe. In a preferred embodiment, separate settings exist for hard and soft setbacks, where a hard setback is a setback after a hard divider or monument, and a soft setback follows a soft divider. In another preferred embodiment, the offset may be associated with the seat class.

Preferably, subsequent seats are then set according to the current seat pitch for the seat class 588. In a preferred embodiment, this seat pitch has an initial default value, and may also be adjustable by the user. Preferably, the optimizing module places seats at this pitch until an interfering component is reached or the seat class ending location is reached. In a preferred embodiment, an interfering component can be a monument or an exit. Preferably, if an interfering component is reached, a new seat bank should be started immediately after the interfering component 590. In a preferred embodiment, this process is repeated for every seat class for each of the left, right and center (if present) seat placements.

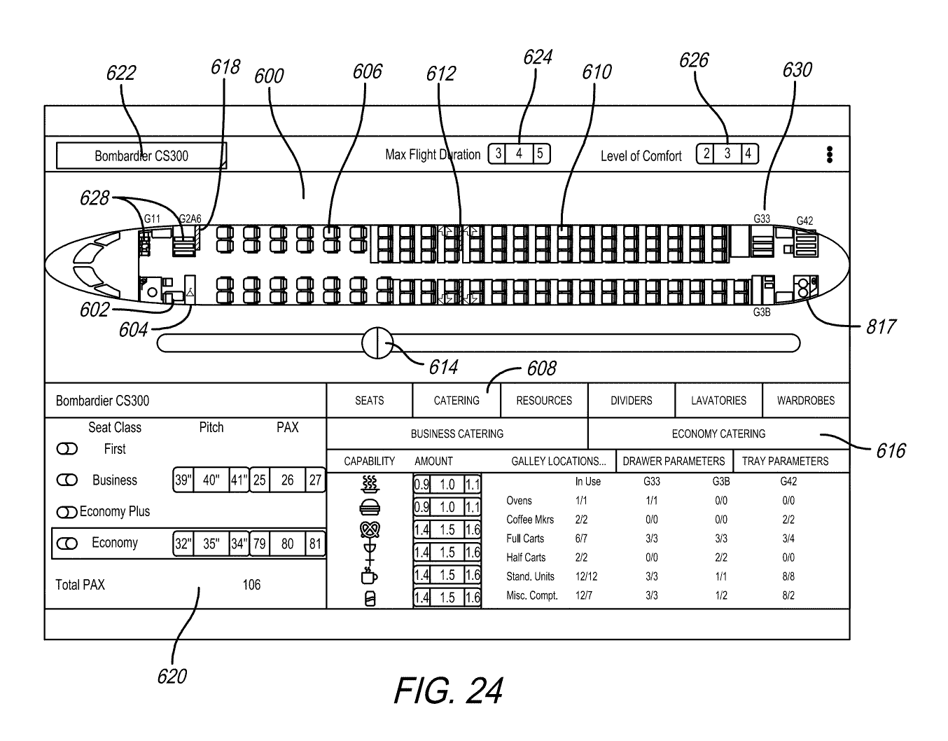

FIG. 24 is an exemplary graphic user interface of the software application (400) of a preferred embodiment. In a preferred embodiment, and as shown in FIG. 21, roughly the upper half of the screen is devoted to rendering the LOPA 601. Preferably, as shown, the interior of the airframe includes dimensionally accurate renderings of monuments such as galleys 628, wardrobes 604, and lavatories 817. Additional information regarding the monuments is displayed in text near the monuments 630. In a preferred embodiment, this text may report global resource allocations, widths of different monuments, the names of monuments, or resource allocations specific to a particular seat class. Preferably, exits 602 and emergency exits 612 are also displayed. In a preferred embodiment, seat classes 610 are each displayed in a format that provides the seat pitch and number of seats across a row. Preferably, if dividers between seat classes are enabled, the dividers are also rendered in a “what you see is what you get” (WYSIWYG) format. In a preferred embodiment, the precise number and location of seats in each seat class may be modified by moving circular sliders 614 that appear beneath the LOPA. Preferably, moving these sliders will automatically recalculate not only the seat locations, but also the optimal monument set necessary to support the passenger requirements. In a preferred embodiment, any empty space that has not been filled by expanding monuments is shown as a crosshatched region 618. In a preferred embodiment, a textual overview of the airframe layout 620 is provided on a lower-left side panel. Preferably, seat totals for each seat class and for the airframe are shown, as adjustable UI elements and may be modified by the user. In a preferred embodiment, seat pitches for each seat class are similarly displayed and modifiable. Finally, in a preferred embodiment, entire seat classes may be enabled or disabled using toggle-switch UI elements. Preferably, the current airframe 622 is displayed on a pull down menu, which, if selected, will display a list of alternative airframes that may be switched to.

In a preferred embodiment, tabbed UI panels such as catering tab 608 allow for more detailed configuration of the airframe. In particular, tabs provide for configuration of seats, catering, seat-specific resources, dividers, lavatories, and wardrobes. Preferably, each of the main tabs has one or more sub-tabs, such as the economy catering subtab 616 of catering tab 608, which correspond to each supported seat class. In a preferred embodiment, each of the main tabs may independently configure each of the airframe's seat-class specific parameters. Preferably, the monuments associated with each seat class can be configured within a tab corresponding to that seat class. In a preferred embodiment, the software application 400 provides sliding UI elements allowing a user to adjust the maximum flight duration 624 and level of comfort 626.

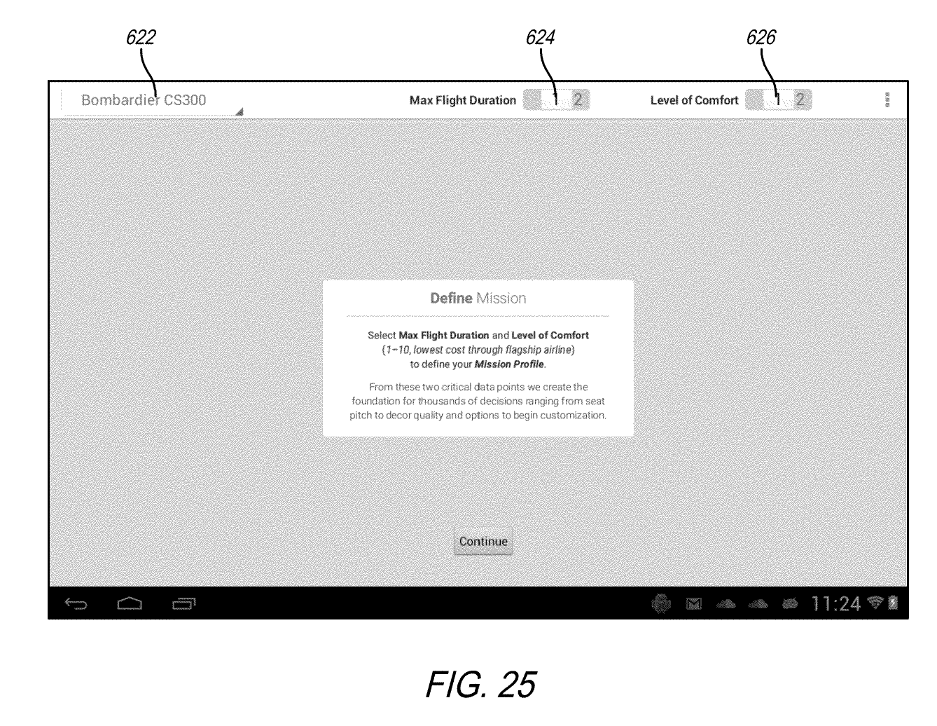

FIG. 25 is an exemplar screen shot showing the user interface displayed by the software application 400 when it is first started. A “Define Mission” overlay hides the details of the software application 400. The software application 400 also provides an active fuselage selection pulldown 612, which allows a user to select the fuselage that is to be configured. As described above, the software application 400 also provides a flight duration slider 624 and the level of comfort slider 626, which allow a user to modify the flight duration and comfort level values, respectively. In a preferred embodiment, the software application 400 supports the use of help overlays such as the “Define Mission” overlay. These overlays provide help and instruction to new users regarding how to best use the software application 400 when it is first run. For example, the “Define Mission” overlay directs the user to select default values for flight duration and comfort level before configuring other parameters. A help overlay can direct the user to configure seat class selections, seat section lengths, and seat pitches before configuring the catering options. Those of ordinary skill in the art will appreciate that the “Define Mission” overlay is merely an exemplary help overlay and that other help overlays may be provided by the software application 400.

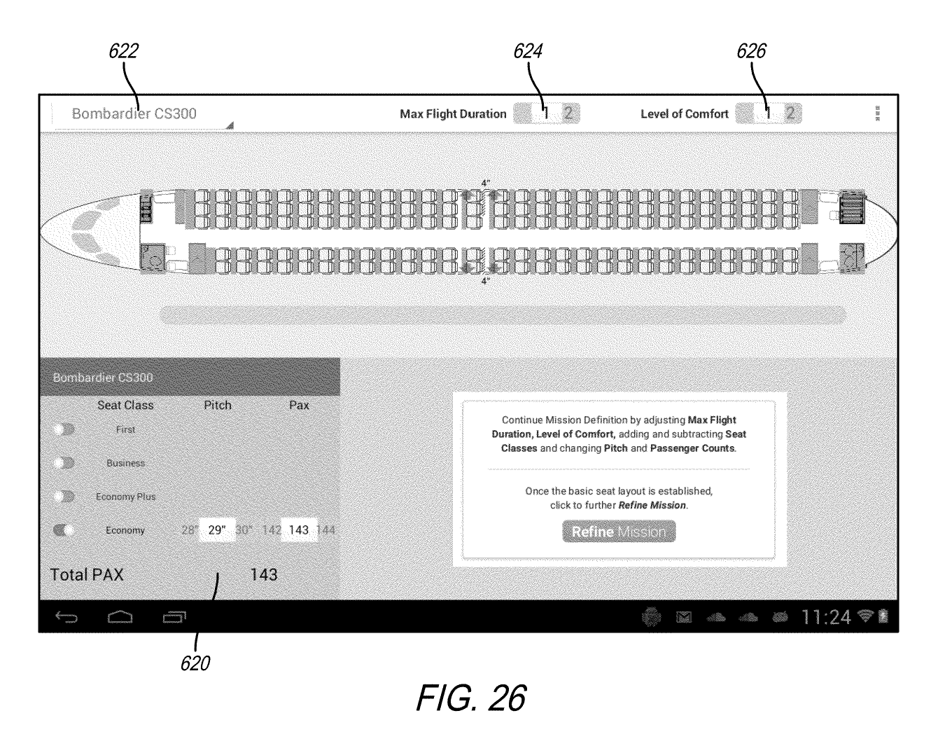

FIG. 26 is an exemplar screen shot showing the user interface displayed by the software application 400 after the flight duration and level of comfort have been selected by a user. The software application 400 displays the user's selections of fuselage type 612, maximum flight duration 624, and level of comfort 626. Additionally, a configuration panel 620 is shown, which the user may use to select active seat classes and the associated seat pitch and passenger count. The user is directed to refine mission requirements after these selections have been made.

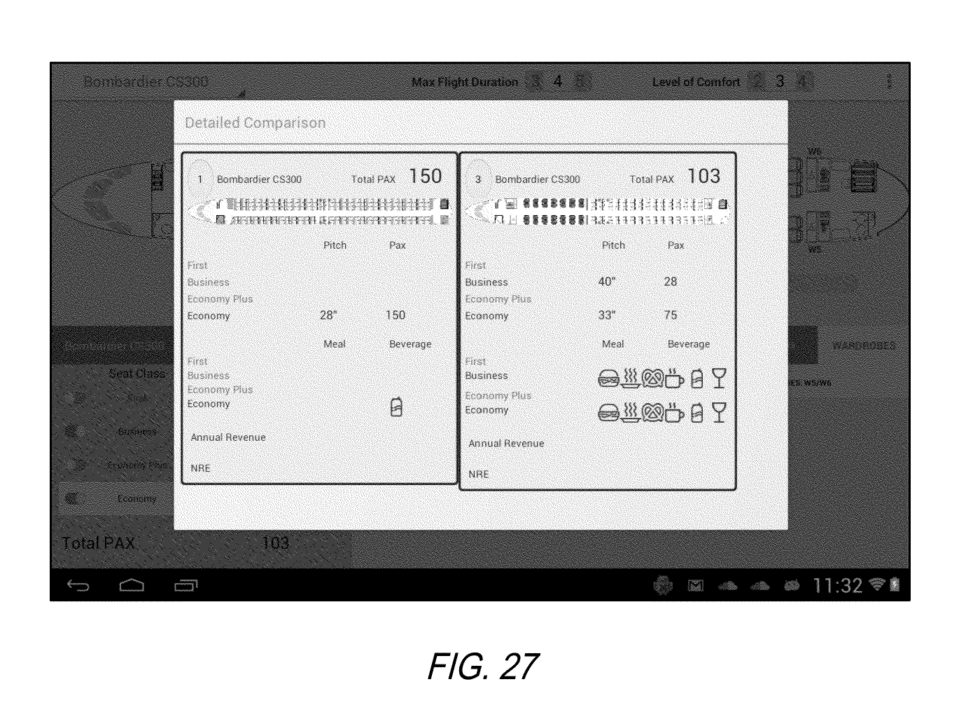

FIG. 27 is an exemplar screen shot of the detailed fuselage comparison feature of the software application 400. In the exemplary use shown in FIG. 27, two airframes are being compared, one with 150 passengers, and the other with 103 passengers. The software application 400 displays detailed differences between the fuselages, such as different seat classes, seat pitches, and catering services, allowing these differences to be compared at a glance. The detailed fuselage comparison feature of the software application 400 provides a comparison of a greater number of features relative to the basic fuselage comparison, including seat pitch for each seat class, and a summary of catering services provided for each seat class, displayed as an icon (i.e., an icon of a cup of coffee is used to convey that hot beverage service is provided, a wine glass is used to convey that alcohol is served, etc.).

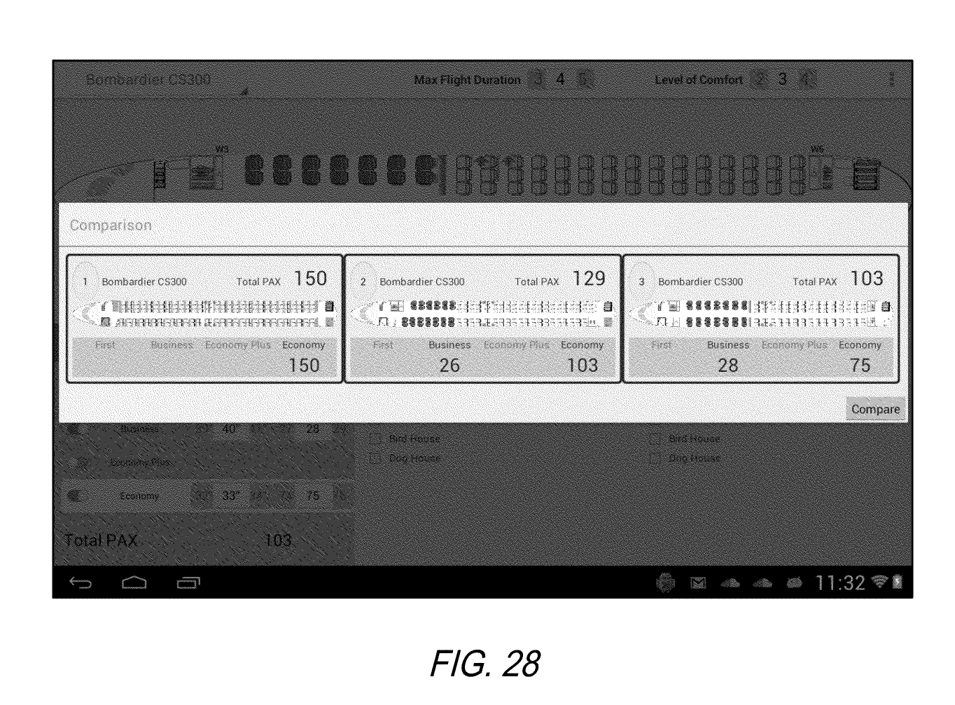

FIG. 28 is an exemplar screen shot showing the basic fuselage comparison feature of the software application 400. As shown in FIG. 28, the basic fuselage comparison feature allows multiple fuselages to be compared at a glance. In a preferred embodiment, the software application 400 displays a LOPA rendering tile for each fuselage, along with an overall passenger count and a passenger count for each active seat class. In a preferred embodiment, the software application 400 displays a plurality of saved LOPAs as tiles, each tile containing basic information such as the fuselage name, the total number of passengers, the number of passengers per seat class, and a simple rendering of the LOPA. In a preferred embodiment, a user may then select two or three of these tiles for a more detailed comparison.

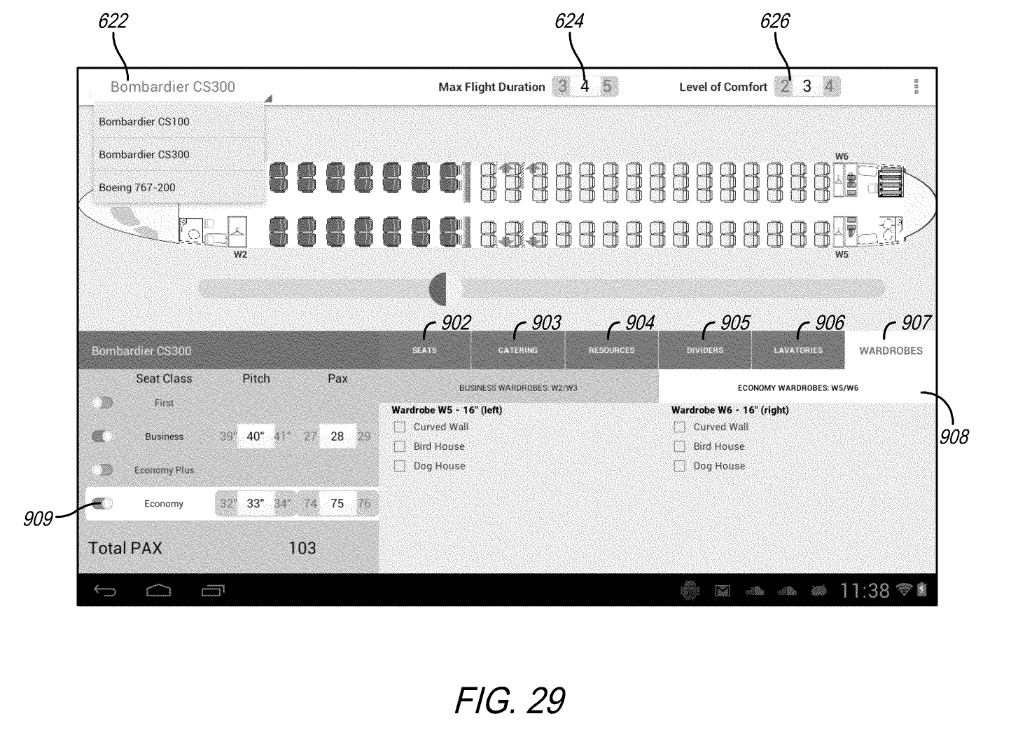

FIG. 29 is an exemplar screen shot of the software application 400 showing the wardrobe configuration panel. The UI elements showing the currently selected fuselage 612, flight duration 624, and level of comfort 626 are shown across the top of the screen. Other possible fuselage selections are also shown in a pulldown menu 612. A scaled rending of the LOPA is shown in the upper half of the screen. The software application 400 provides tabs that the user can select to configure the seats 902, catering 903, resources 904, dividers 905, lavatories 906, and wardrobes 907. As shown in FIG. 29, the wardrobe tab 907 is selected, allowing an end user to configure the wardrobes associated with the economy seat class. Wardrobe configuration is configured on a per-seat-class basis. All wardrobes associated with a particular seat class may be configured on that seat class's wardrobe configuration tab. For example, as shown in FIG. 29, the subtab for economy class wardrobes 908 is selected, allowing the user to configure wardrobes associated with the economy seat class. Wardrobe options can include curved wall, bird house, and dog house. A curved wall results in a lavatory or wardrobe that curves to match the angle of a reclining seat. If a curved wall is not selected, the birdhouse and/or doghouse options may be selected. These are storage units that go above and behind the seat immediately in front of a lavatory or wardrobe, or directly behind the seat immediately in front of a lavatory or wardrobe. The software application 400 provides a business tab, the selection of which allows a user to modify the wardrobes associated with the business class seats, if any. As shown in FIG. 29, in a preferred embodiment, software application 400 also displays seat class configuration options 909, which allow a user to select or decline available seat classes and configure the pitch and passenger counts of selected seat classes.

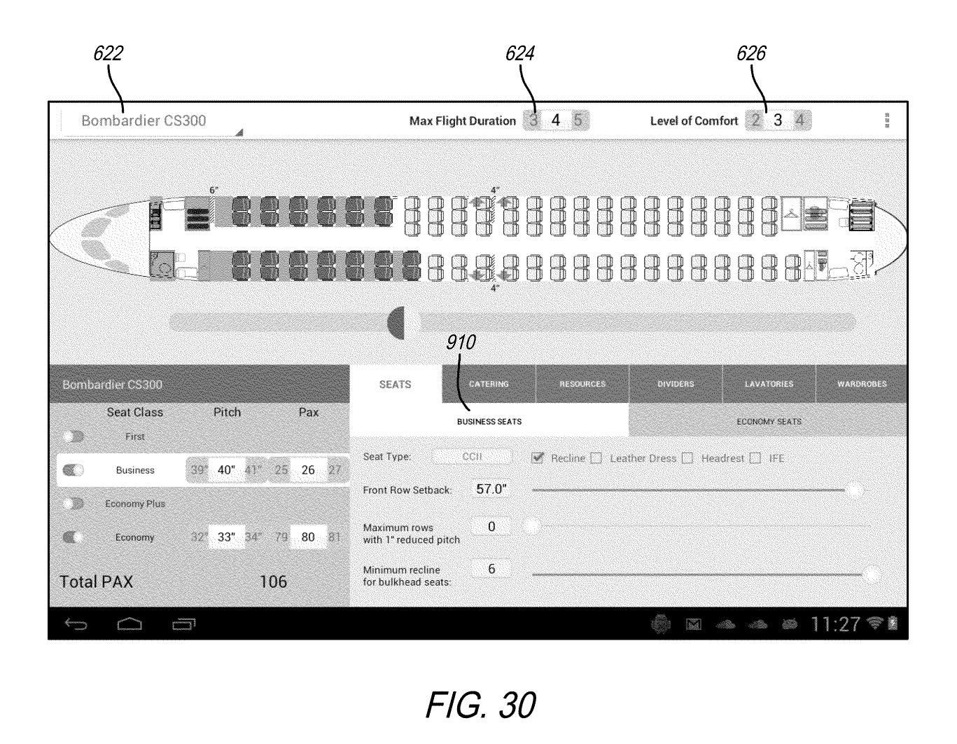

FIG. 30 is an exemplar screen shot showing the seat configuration panel displayed by the software application 400. The UI elements showing the current selections of a fuselage 612, flight duration 624, and level of comfort 626 are shown across the top of the screen. The business seats subtab 910 of the seats tab 902 is selected, allowing an end user to configure the business class seats. The seats tab allows a user to configure seat-specific settings. For example, the type of seat may be selected. The list of seat-specific settings is limited to features supported for a particular seat class. For example, an economy or “economy plus” seat class would not allow selection of a first-class style seat. Seat options specific to a seat type are also displayed. These may include, for example, optional recline, leather dress, or in-flight entertainment options. Various safety regulations often require the first seat in a seat row to have a longer seat back (pitch) compared with the seats that follow it. This front row setback may be configured within the seats tab 902. To maximize the number of seats on the plane, often the last row or last few row may have their pitch reduced by one inch. The maximum number of rows with one inch of reduced seat pitch may be set by the user within the seats tab 902. Selecting zero rows never reduces the seat pitch, and selecting all rows allows all rows to be reduced in pitch if it results in an extra seat row. The last seat row in front of a bulkhead may have a reduced amount of recline. The minimum recline for the last row is a user-configurable option as well. The software application 400 will ensure that at least this amount of recline is supported when configuring the interior.

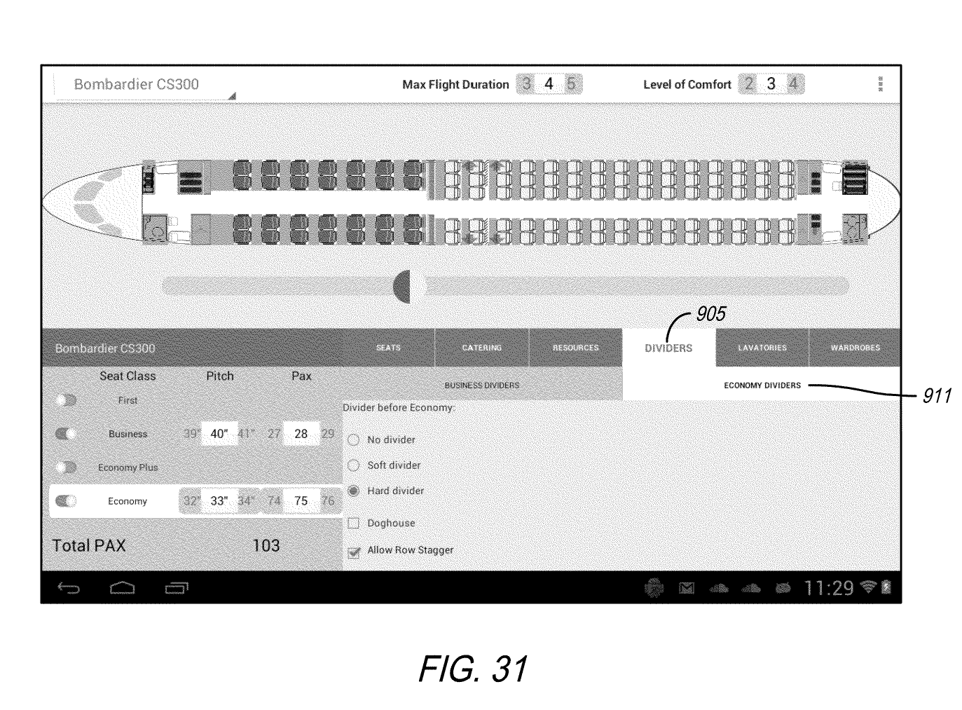

FIG. 31 is an exemplar screen shot of the software application 400 showing the dividers configuration panel. The economy dividers subtab 911 of the dividers tab 905 is selected, allowing a user to configure the economy class dividers. Divider configuration is also performed on a per-seat-class basis. Preferably, each seat class may be physically separated by a hard divider or a soft (cloth) divider. However, a user may opt to not use a divider at all. For example, the boundary between economy and economy plus is often not marked with a physical divider. If a hard divider is selected, a user may opt to place a doghouse (storage unit) at the foot of the divider, behind the last seat row in front of the divider. Generally, the software application 400 allows a user to select row-stagger as a way of further optimizing the airframe layout. When row stagger is enabled, the software application 400 permits a configuration in which seats on the left and right sides of an aisle may not be aligned.

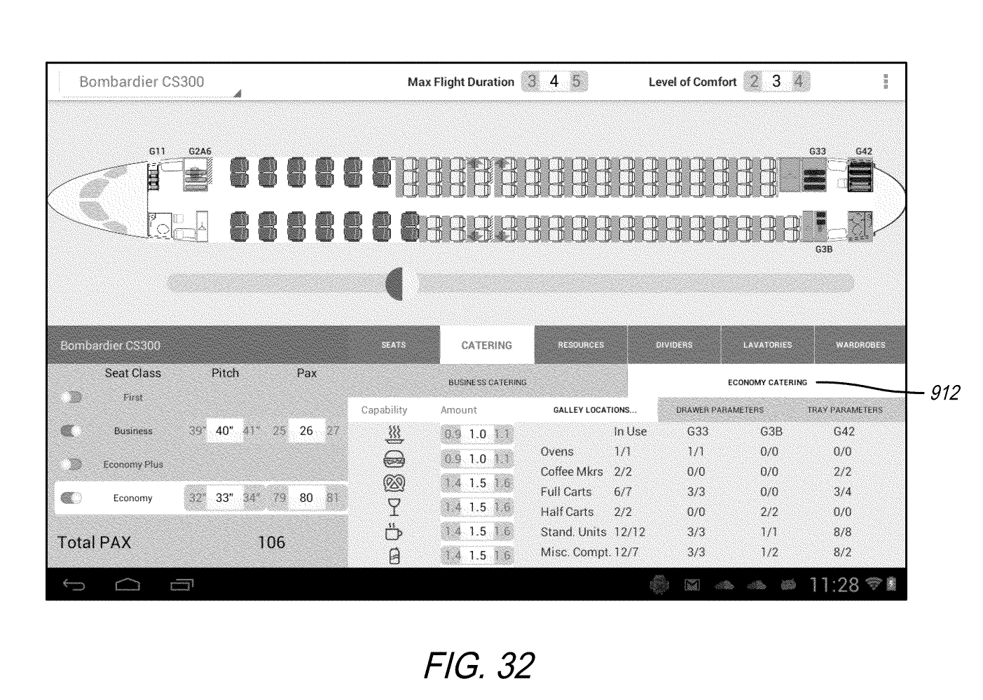

FIG. 32 is an exemplar screen shot of the software application 400 showing the catering configuration panel. As shown in FIG. 32, the economy catering subtab 912 of the catering tab 903 is selected, which allows an end user to configure the economy class catering. The software application 400 also displays Drawer Parameters and Tray Parameters subtabs. These subtabs and UI elements within these substabs may be used to configure the drawer and tray settings for the seat class. Drawer parameters can include, for example, the number of coffee cups, plastic cups, napkins, soft drinks, and liquor bottles that can fit in each drawer. Tray parameters can include, for example, the number of hot meals, cold meals, and snacks that can fit in each tray. In a preferred embodiment, the software application 400 utilizes the drawer and tray settings to determine how many trays and drawers, and in turn, trolleys and standard units, are required to store the requested catering supplies. Preferably, the software application 400 allows a user to configure the number of trays and drawers that can fit within a trolley or standard unit.

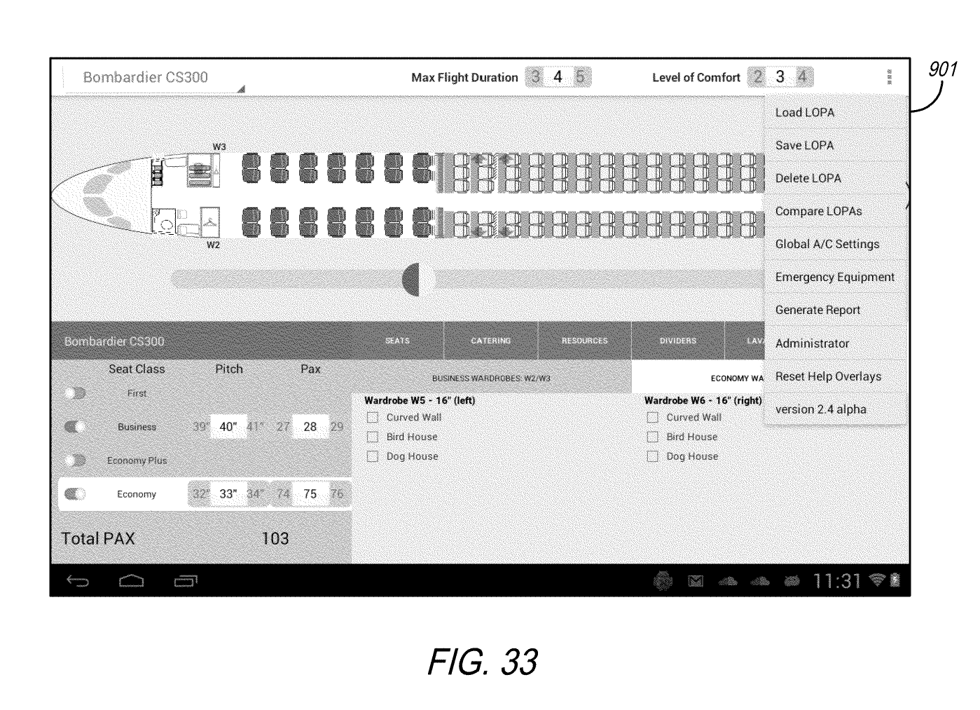

FIG. 33 is an exemplar screen shot of the application overflow menu 901 of the software application 400, by which the user can select options that can be processed such as shown in FIG. 17 442, 446, 448, 456, 450, 452, 454.

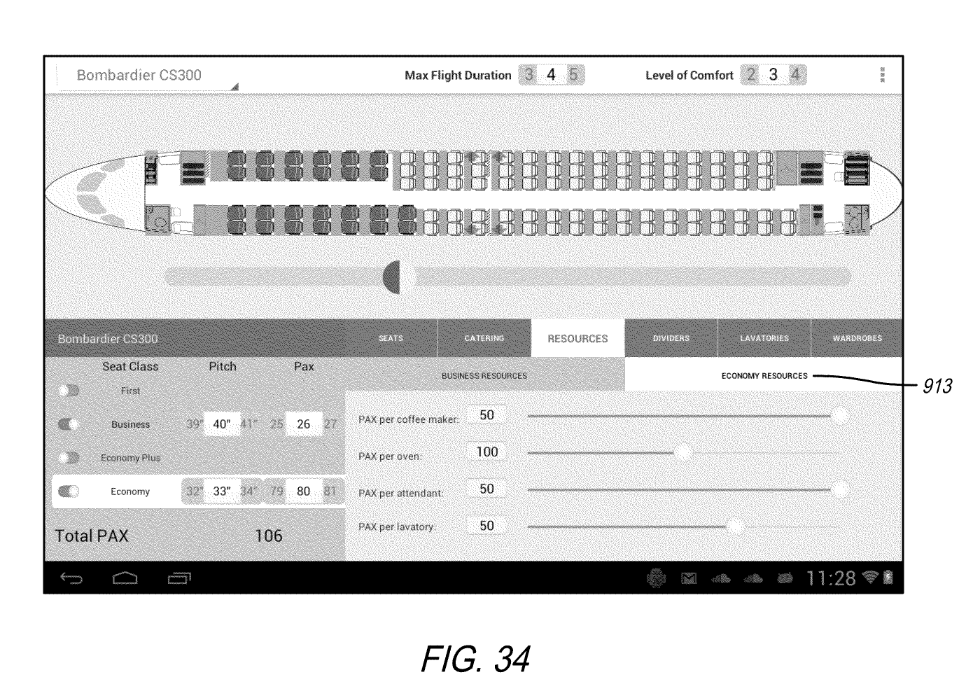

FIG. 34 is an exemplar screen shot of the software application 400 displaying the resources configuration panel. Seat class-specific resources are configurable within their own subtab. For example, as shown in FIG. 34, the economy resources subtab 913 of the resources tab 904 is selected and the software application 400 allows an end user to configure the economy resources. The resources values are used to drive the monument allocation algorithm of the optimizing module 408, as shown in FIG. 21. Resources that may be configured include, for example, the number of passengers supported by each coffee maker, the number of passengers supported by each oven, the number of passengers supported by each flight attendant, and the number of passengers supported by each lavatory. Resource allocations are selected on a per-seat-class basis. For example, first class will typically provide more attendants and lavatories per passenger than economy class. The number of attendants is used to determine the number of jump seats provided for the fuselage.

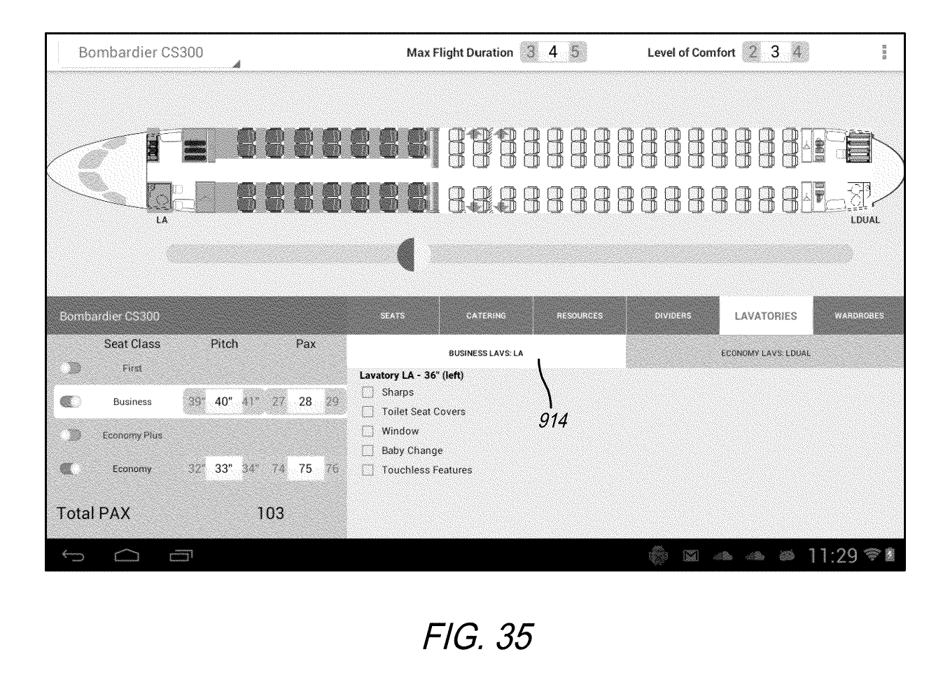

FIG. 35 is an exemplar screen shot of the software application 400 showing the lavatory configuration panel. The business lavatory subtab 914 of the lavatory tab 906 is selected, and thus the software application 400 allows a user to configure the economy class lavatories. Lavatory configuration is also performed on a per-seat-class basis. All lavatories associated with a particular seat class may be configured on that seat class's lavatory configuration tab. Lavatory options consist of boolean values that are associated with each lavatory in the central database 410. Examples of lavatory options include toilet seat covers, a baby change station, and touchless features.

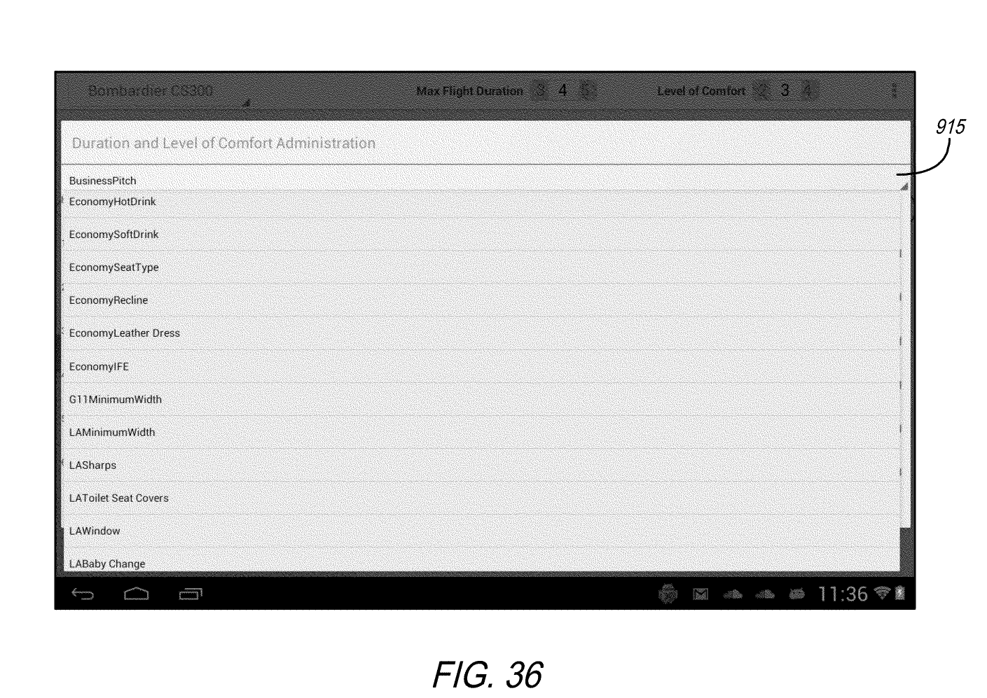

FIG. 36 is an exemplar screen shot of the Duration and Level of Comfort administration selection dialog displayed by the software application 400. The software application 400 displays a list of DurLOCs 915, and a user with administrative privileges may select a DurLOC from the list of DurLOCs 915 in order to modify the settings for the selected DurLOC. In a preferred embodiment, any changes to a DurLOC will impact all users of the application that subsequently load the modified DurLOCs.

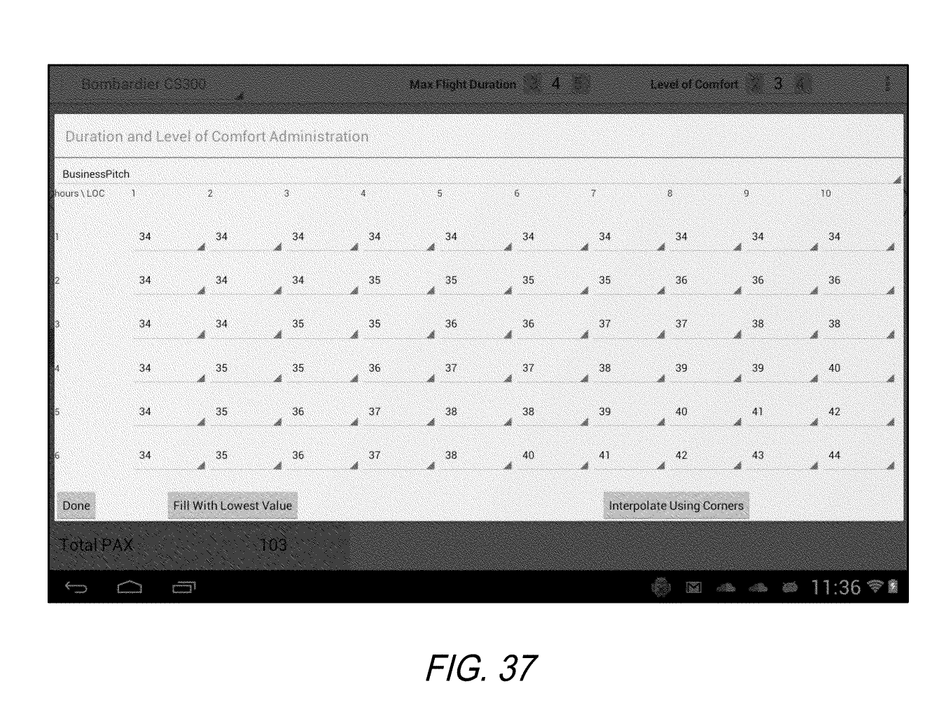

FIG. 37 is an exemplar screen shot of the Duration and Level of Comfort administration dialog as displayed by software application 400. As shown in FIG. 37, the DurLOC for Business class seat pitch is displayed with level of comfort values along the horizontal axis and flight duration values along the vertical axis. An administrative user may modify these settings in order to change the default values for business class seat pitch for all users as a function of the flight duration and level of comfort values. In a preferred embodiment, as shown in FIG. 37, there are ten comfort level settings and six flight duration settings. Thus, the table is a ten by six matrix containing sixty total settings. However, it will be understood by those of ordinary skill in the art that other pluralities of level of comfort settings and duration settings, or any other settings for features, may be used. Preferably, any entry in the matrix may be modified by the administrative user. The administrative user may also reset all values to their lowest setting. The user may also define a gradient of values, by selecting values in four corners of the matrix, and the using those four values to interpolate the remaining values using a special gradient. For boolean settings, a user may select two values along the perimeter of the matrix, and by using those two values as a boundary region, the software application 400 can create a linear transition zone between one boolean region and another in the matrix. In other words, one side of the transitional zone will show true, and the other half will show false. Most boolean matrices have a transition zone of this style, and so this feature of the software application 400 can simply the correct settings in these matrices.

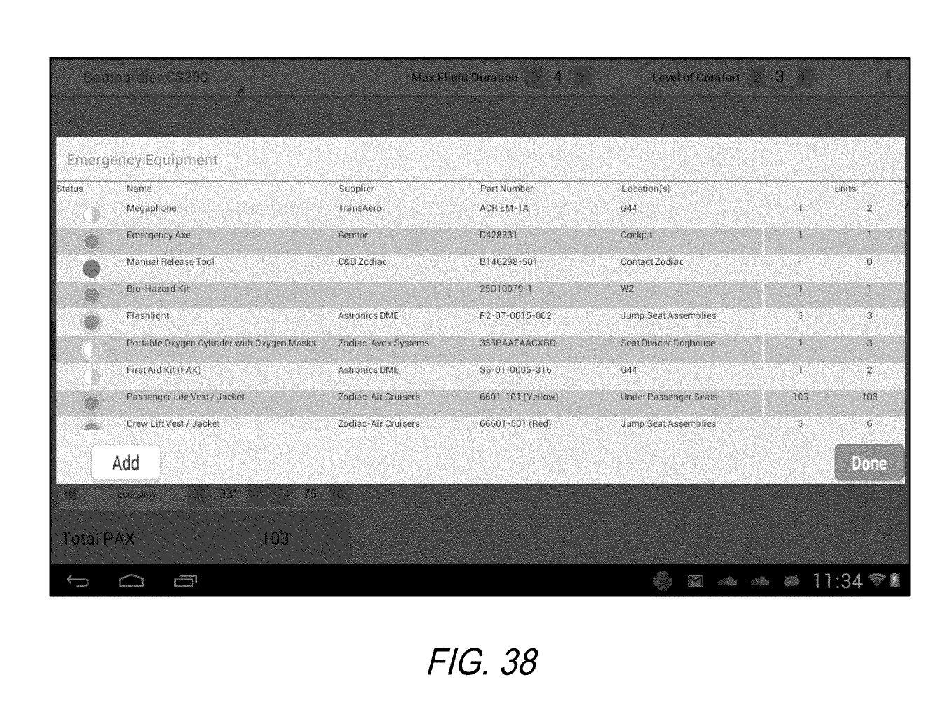

FIG. 38 is an exemplar screen shot of the Emergency Equipment Configuration Dialog provided by the software application 400. The software application 400 allows for selected emergency equipment to be provisioned for the fuselage. In a preferred embodiment, a list of default emergency equipment for each fuselage is stored in the central database. Preferably, for each type of emergency equipment that is provisioned by default for an fuselage, the following information is stored: The name of the emergency equipment (e.g., emergency axe); the supplier of the equipment; the part number of the equipment; the location(s) on the fuselage where the emergency equipment may be stored; and the total number suggested for the airframe. As some monuments may provide storage for certain types of emergency equipment, whereas other monuments may not, those of ordinary skill in the art will understand that the allowable storage locations for emergency equipment will change with different monument sets. In other words, some airframe configurations may not provide storage locations for all emergency equipment by default. In a preferred embodiment, the software application 400 automatically places emergency equipment into an appropriate storage location using a hierarchy of preferred locations. For example, the preferred location for a fire extinguisher may be within a G41-type monument, but in the absence of this monument, the fire extinguisher may have to be placed in an overhead bin. This location may be less preferred because the overhead bin space is best left available for passenger baggage. Thus, a user might prefer to locate emergency equipment in areas other than the overhead bins. In a preferred embodiment, the software application 400 allows a user to place the emergency equipment in preferred locations by tracking allowable locations for emergency equipment. The software application 400 also serves as a checklist, ensuring that all required emergency equipment has been placed. Finally, the software application 400 reminds the user that certain emergency equipment has not been placed, and can serve as a starting point for a dialog with the airframe interior customer. The software application 400 may also optimize the placement of emergency equipment, for example, by minimizing the amount of overhead bin space lost to emergency equipment that could not be placed elsewhere.

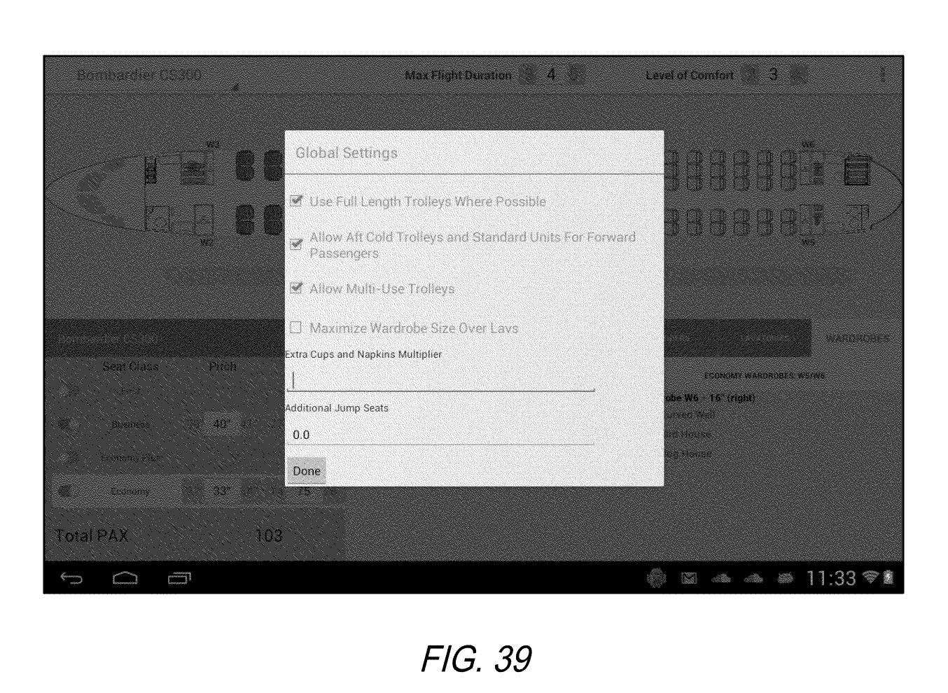

FIG. 39 is an exemplar screen shot of the Global Settings Dialog displayed by the software application 400. Certain parameters, settable by the user, impact overall aircraft provisioning, and may be set globally through the Global Settings Dialog. Catering trolleys are available in two varieties: full-length and half-length. Twice as many half-length trolleys may fit into a given galley as full-length trolleys. Some galleys are designed such that they only accommodate half-length trolleys. Consequently, some aircraft have a mixture of half-length only galleys and full-length galleys. A user may desire to standardize these planes to only use half-length galleys, or they may wish to use a mixture of galley types. A boolean parameter controls this selection globally. For meal service, it may be desirable to store cold meals, snacks, and drinks in aft storage areas (trolleys or standard units), for use by forward-sitting passengers. This may allow a smaller galley to be used at the front of the plane, saving some space. However, some airlines may not wish to necessitate this “trolley juggling”, wherein trolleys of catering supplies must be brought from the back to the front of the plane. Whether or not to allow trolley juggling impacts the monument configuration, and may be set globally using a boolean parameter. An improvement in catering storage efficiency occurs when different catering supplies may be stored on the same trolley. For example, if both hot and cold meals are stored on the same trolley, one less trolley may be needed in some instances. However, this results in complexities when trying to track and serve the catering supplies. The software application 400 uses a global boolean to control whether or not this optimization is allowed. After selecting the optimal monument set, there is typically extra space that must be consumed by enlarging the seat pitch, increasing the wardrobe sizes, or increasing the lays. In a preferred embodiment, the wardrobe sizes are increased by default, rather than the lavatory sizes. However, in another preferred embodiment, the software application 400 can allow the user to opt to increase the lavatory sizes rather than the wardrobe sizes by setting a boolean global value.

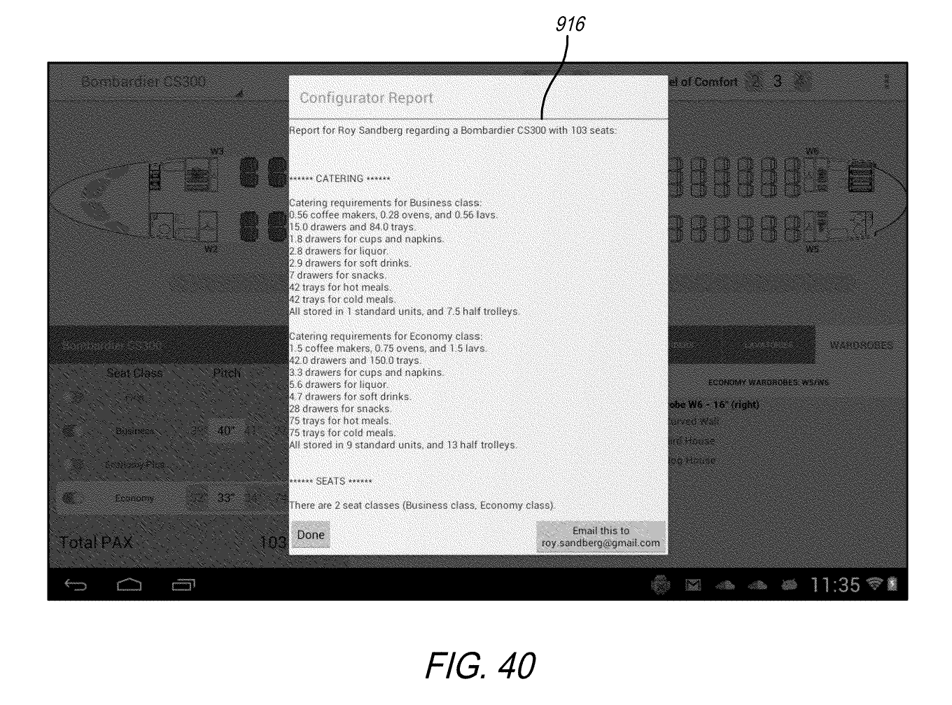

FIG. 40 is an exemplar screen shot showing the Report Generation Dialog provided by the software application 400. A report 916 for a Bombardier CS300 airframe is shown. As shown in FIG. 40, the Report Generation Dialog can show the seat classes in the LOPA and catering requirements for those seat classes.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U. S. C. §112, ¶6, other aspects may likewise be embodied as a means-plus-function claim, or in other forms, such as being embodied in a computer-readable medium. (Any claims intended to be treated under 35 U. S. C. §112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A computerized system for determining the design layout of an aircraft, the system comprising:
an input module configured to receive a first input data indicating a first value of a first parameter;
a first feature database that includes a plurality of feature settings;
a feature search module configured to search the first feature database and select a feature setting based on the first value of the first parameter;
a central database that includes a plurality of rules governing a design layout of a fuselage; and
an optimizing module in communication with the central database and configured to generate an optimal design layout based on the selected feature setting.

2. The computerized system of claim 1,
wherein the input module is further configured to receive a second input data indicating a first value of a second parameter; and
wherein the feature search module is further configured to search the first feature database and select the feature setting based on the first value of the first parameter and the first value of the second parameter.

3. The computerized system of claim 1, wherein the first parameter is comfort level.

4. The computerized system of claim 1, wherein the first parameter is flight duration.

5. The computerized system of claim 2, wherein the first parameter is comfort level and the second parameter is flight duration.

6. The computerized system of claim 1,
wherein the optimizing module is further configured to apply at least one of the plurality of rules to generate a list of possible combinations of aircraft component layout configurations; and
wherein the optimizing module is configured to generate an optimal layout configuration by selecting, based on the selected feature setting, one aircraft component layout configuration from the list of possible combinations of aircraft component layout configurations.

7. The computerized system of claim 6, wherein the optimizing module is further configured to generate an optimal design layout by determining and selecting the one configuration, from the list of possible combinations of aircraft component layout configurations, that provides for a greatest number of seats.

8. The computerized system of claim 7, wherein the optimizing module is further configured to generate an optimal design layout by determining and selecting the one configuration, from the list of possible combinations of aircraft component layout configurations, that provides for a least amount of seat compromise.

9. The computerized system of claim 8, wherein the optimizing module is further configured to generate an optimal design layout by determining and selecting the one configuration, from the list of possible combinations of aircraft component layout configurations, that provides for a most amount of free space.

10. The computerized system of claim 9, wherein the optimizing module is further configured to generate an optimal design layout by determining and selecting the one configuration, from the list of possible combinations of aircraft component layout configurations, that has a highest monument ranking.

11. A computer-implemented method for optimizing the design layout of an aircraft, the computer-implemented method comprising the steps of:
receiving a first input data indicating a first value of a first parameter;
searching a first feature database and selecting a feature setting based on the first value of the first parameter; and
generating an optimal design layout based on the selected feature setting.

12. The computer-implemented method of claim 11, further comprising the steps of:
receiving a second input data indicating a first value of a second parameter; and
searching the first feature database and selecting the feature setting based on the first value of the first parameter and the first value of the second parameter.

13. The computer-implemented method of claim 11, wherein the step of generating an optimal design layout further comprises generating a list of possible combinations of aircraft component layout configurations, and selecting, based on the selected feature setting, one aircraft component layout configuration from the list of possible combinations of aircraft component layout configurations.

14. The computer-implemented method of claim 11, wherein the first parameter is comfort level.

15. The computer-implemented method of claim 11, wherein the first parameter is flight duration.

16. The computer-implemented method of claim 12, wherein the first parameter is comfort level and the second parameter is flight duration.

17. The computer-implemented method of claim 13, wherein the step of generating an optimal design layout further comprises determining and selecting the one configuration, from the list of possible combinations of aircraft component layout configurations, that provides for a greatest number of seats.

18. The computer-implemented method of claim 17, wherein the step of generating an optimal layout configuration further comprises determining and selecting the one configuration, from the list of possible combinations of aircraft component layout configurations, that provides for a least amount of seat compromise.

19. The computer-implemented method of claim 18, wherein the step of generating an optimal layout configuration further comprises determining and selecting the one configuration, from the list of possible combinations of aircraft component layout configurations, that provides for a most amount of free space.

20. The computer-implemented method of claim 19, wherein the step of generating an optimal layout configuration further comprises determining and selecting the one configuration, from the list of possible combinations of aircraft component layout configurations, that has a highest monument ranking.
